(19) United States
(12) Patent Application Publication
(10) Pub. No.: US 2003/0202525 A1
(43) Pub. Date: Oct. 30, 2003

(54) Packet transfer apparatus, scheduler, data transfer apparatus, and packet transfer method

(75) Inventor: Teruhiko Nagatomo, Kanagawa (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/342,252

(22) Filed: Jan. 15, 2003

(30) Foreign Application Priority Data
Apr. 25, 2002 (JP) 2002-123665

(51) Int. Cl. H04L 12/56

(52) U.S. Cl. 370/411; 370/395.4

(57) ABSTRACT

A packet transfer apparatus, a scheduler, a data transfer apparatus, and a packet transfer method which can control a transfer rate for each attribute according to an operational situation. When a packet is input, the buffer control circuit determines an attribute of the packet. The input packet is stored by the buffer control circuit in a buffer area which is associated with the determined attribute in advance. Thereafter, when it becomes possible to transmit a packet, the selector refers to information set in a register, and selects a buffer area which has a highest priority among at least one buffer area storing at least one packet. The selection result is sent to the buffer control circuit. Then, buffer control circuit outputs a packet stored in the selected buffer area.

### CROSS-REFERENCE TO RELATED APPLICATIONS

This application is based upon and claims priority of Japanese Patent Application No.2002-123665, filed on Apr. 25, 2002, the contents being incorporated herein by reference.

### BACKGROUND OF THE INVENTION

1) Field of the Invention

The present invention relates to a packet transfer apparatus, a scheduler, a data transfer apparatus, and a packet transfer method. In particular, the present invention relates to a packet transfer apparatus, a scheduler, a data transfer apparatus, and a packet transfer method which perform priority control operations for each attribute of packets.

2) Description of the Related Art

With the widespread use of the information and communications technologies utilizing the Internet, the amount of content transmitted through the Internet is becoming great. In addition, techniques for connecting high-speed communication lines to home computers have been developed, and the amount of each transmitted data item is also becoming great.

Incidentally, when a piece of content is acquired from a web server or the like through the Internet, the piece of content is transferred through one or more data transfer apparatuses to a computer of a user, where the data transfer apparatus has a packet transfer function. For example, the data transfer apparatuses are various types of routers and switching devices.

When data are transferred through a router or the like, and a packet transfer operation in the router or the like is slower than a transmission rate in a communication line, the data transfer throughput decreases even if the transmission rate in the communication line is high. Therefore, a technique enabling efficient transfer of packets transmitted in a network is required.

As one of conventional packet transfer functions, the function of priority control of packets is currently used. In the priority control of packets, priorities are assigned based on attributes of transferred packets, and a packet to which a high priority is assigned is preferentially transferred. Thus, the quality of service (QoS) performed on a packet to which a high priority is assigned can be maintained at a predetermined or higher level.

For example, in some routers, the so-called priority queue method is used as a method for priority control of packets. In such routers, high priority packets are stored in a buffer for priority queuing (PQ), and low priority packets are stored in a buffer for best-effort queuing (BEQ). The priority order of the packets are recognized by referring to header information in the packets. Each router has a scheduler, which preferentially selects packets stored in the buffer for the priority queuing (PQ) as packets to be transmitted, and the packet selected by the scheduler is transmitted.

However, since, according to the conventional priority queue method, the capacity of the buffer for storing packets of each priority is fixed, the following problems exist.

(1) Only packets which are recognized as high priority packets are transmitted when congestion occurs.

(2) There is no freedom to vary the scheduling process.

Therefore, when excessively heavy traffic occurs, at worst, it may happen that packets of only a specific person or group can be transferred. In addition, it is impossible to realize fine-grained rate control, e.g., to dynamically raise or lower the priority.

In the world of the Internet, originally, the so-called best-effort type network mechanism is used. The use of the best-effort type network mechanism is not regarded as a problem in the days when only data communication is carried out. However, recently, new applications such as the IP (Internet Protocol) telephone and the Internet broadcasting are becoming important, and the control of the packet transfer rate has become an important factor for development of the Internet.

### SUMMARY OF THE INVENTION

The present invention is made in view of the above problems, and the object of the present invention is to provide a packet transfer apparatus, a scheduler, a data transfer apparatus, and a packet transfer method which can control a transfer rate for each attribute of packets according to an operational situation.

In order to accomplish the above object, a packet transfer apparatus for transferring communication packets is provided. The packet transfer apparatus comprises: a buffer memory partitioned into a plurality of buffer areas; a buffer control circuit which determines at least one attribute of at least one packet which is input into the packet transfer apparatus, stores the at least one packet in at least one of the plurality of buffer areas which is respectively associated with the at least one attribute in advance, and outputs a packet stored in one of the plurality of buffer areas when the one of the plurality of buffer areas is selected; a plurality of registers in which information indicating priorities of the plurality of buffer areas is set, where the information can be changed during packet transfer processing; and a selector which refers to the information set in the plurality of registers at a packet transmission timing, selects one of the plurality of buffer areas which has a highest priority among at least one of the plurality of buffer areas storing at least one packet, and sends a selection result to the buffer control circuit.

In addition, in order to accomplish the aforementioned object, a scheduler for determining an order of transmission of packets stored in a buffer memory which is partitioned into a plurality of buffer areas is provided. The scheduler comprises: a register in which information which indicates priorities of the plurality of buffer areas and can be varied during packet transfer processing is set; and a selector which refers to the information set in the first register at a packet transfer timing, selects one of the plurality of buffer areas which has a highest priority among at least one of the plurality of buffer areas storing at least one packet, and determines a packet stored in the selected one of the plurality of buffer areas, to be transmitted.

Further, in order to accomplish the aforementioned object, a data transfer apparatus for transferring data between a plurality of networks is provided. The data transfer apparatus comprises: a first communication port; a second communication port; a buffer memory partitioned into a plurality of buffer areas; a buffer control circuit which determines at least one attribute of at least one packet which is input through the first communication port, stores the at least one packet in at least one of the plurality of buffer areas which is respectively associated with the at least one attribute in advance, and outputs through the second communication port a packet stored in one of the plurality of buffer areas when the one of the plurality of buffer areas is selected; a plurality of registers in which information indicating priorities of the plurality of buffer areas is set, where the information can be changed during packet transfer processing; a selector which refers to the information set in the plurality of registers at a packet transmission timing, selects one of the plurality of buffer areas which has a highest priority among at least one of the plurality of buffer areas storing at least one packet, and sends a selection result to the buffer control circuit; and a processor which dynamically changes the information set in the plurality of registers.

Furthermore, in order to accomplish the aforementioned object, a packet transfer method for transferring communication packets through a buffer memory which is partitioned into a plurality of buffer areas is provided. The packet transfer method comprises the steps of: (a) determining at least one attribute of at least one packet which is input, and storing the at least one packet in at least one of the plurality of buffer areas which is respectively associated with the at least one attribute in advance; (b) at a packet transmission timing, referring to information indicating priorities of the plurality of buffer areas, and selecting one of the plurality of buffer areas which has a highest priority among at least one of the plurality of buffer areas storing at least one packet; and (c) outputting a packet stored in the selected one of the plurality of buffer areas.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the invention which is realized in embodiments;

FIG. 2 is a diagram illustrating a system construction in the first embodiment of the present invention;

FIG. 3 is a block diagram illustrating functions of a packet transfer apparatus;

FIG. 4 is a block diagram illustrating a construction of a multischeduler;

FIG. 5 is a diagram illustrating an example of a determination circuit;

FIG. 6 is a diagram illustrating a construction of a selector;

FIG. 7 is a conceptual diagram illustrating rearrangement processing by a rewrite logic;

FIG. 8 is a conceptual diagram illustrating processing for update of a weight which is set for a transmission request;

FIG. 9 is a first flow diagram indicating a sequence of processing performed by the rewrite logic;

FIG. 10 is a second flow diagram indicating a sequence of processing performed by the rewrite logic;

FIG. 11 is a third flow diagram indicating a sequence of processing performed by the rewrite logic;

FIG. 12 is a conceptual diagram illustrating an example of a change of a boundary value;

FIG. 13 is a diagram illustrating a concrete example of the first embodiment;

FIG. 14 is a flow diagram indicating a sequence of processing for changing a boundary value;

FIG. 15 is a block diagram illustrating a construction of a data transfer apparatus in the second embodiment of the present invention;

FIG. 16 is a diagram illustrating an example of a priority control service performed on packets which are input through communication interfaces;

FIG. 17 is a block diagram illustrating an internal construction of a packet transfer apparatus in the second embodiment of the present invention;

FIG. 18 is a block diagram illustrating a construction of a multistage multischeduler;

FIG. 19 is a block diagram illustrating a construction of a first-stage multischeduler; and

FIG. 20 is a block diagram illustrating a construction of a second-stage multischeduler.

### DESCRIPTION OF THE PREFERRED EMBODIMENTS

Embodiments of the present invention are explained in detail below with reference to drawings.

First, an outline of the invention which is realized in the embodiments is explained, and thereafter details of the embodiments are explained.

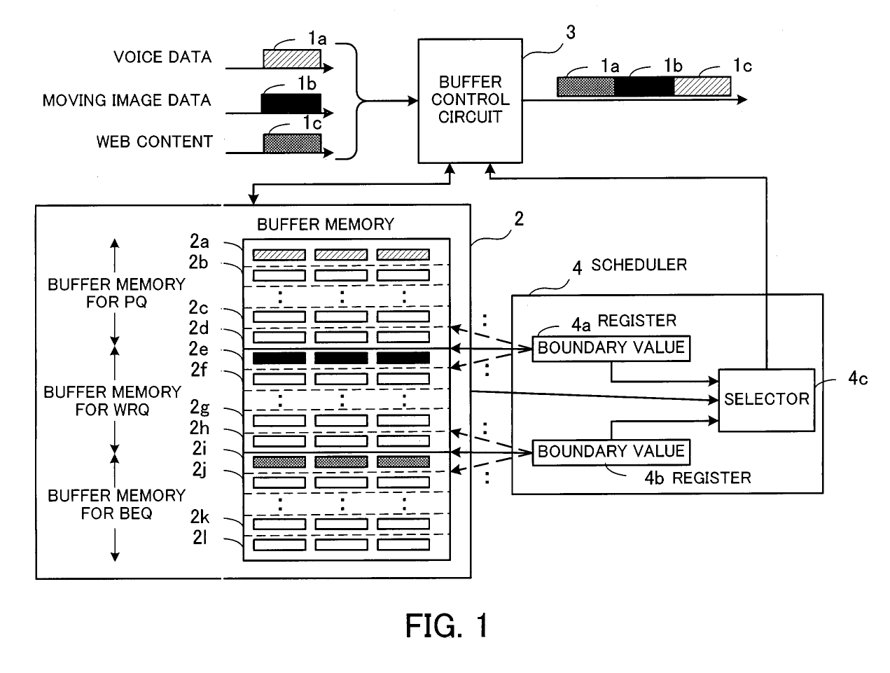

FIG. 1 is a conceptual diagram illustrating the invention which is realized in embodiments. The packet transfer apparatus outputs packets 1a to 1c which are input into the packet transfer apparatus, in a predetermined order. The packet transfer apparatus comprises a buffer memory 2, a buffer control circuit 3, and a scheduler 4.

The buffer memory 2 is partitioned into a plurality of buffer areas 2a to 2l.

The buffer control circuit 3 determines the attributes of the packet 1a to 1c, and stores the packets 1a to 1c in buffer areas which are associated with the determined attributes in advance. In addition, when one of the plurality of buffer areas 2a to 2l is specified, the buffer control circuit 3 outputs a packet stored in the specified one of the plurality of buffer areas 2a to 2l.

The scheduler 4 comprises registers 4a and 4b and a selector 4c. Information indicating priorities assigned to the plurality of buffer areas 2a to 2l are set in the registers 4a and 4b. This information can be dynamically changed during operations for packet transfer processing. At a packet transmission timing, the selector 4c refers to the information set in the registers 4a and 4b, selects a buffer area to which the highest priority is assigned, from among at least one buffer area in which at least one packet is stored, and sends the selection result to the buffer control circuit 3.

When packets 1a to 1c are input into the data transfer apparatus having the above construction, the buffer control circuit 3 determines the attributes of the packets 1a to 1c. The buffer control circuit 3 stores in buffer areas which are associated with the determined attributes. Thereafter, when it becomes possible to transmit packets, the selector 4c refers to the information set in the registers 4a and 4b, selects a buffer area to which the highest priority is assigned, from among buffer areas in which packets are stored, and sends the selection result to the buffer control circuit 3. Then, the buffer control circuit 3 outputs a packet stored in the selected buffer area.

For example, a case where a packet 1a containing voice data, a packet 1b containing moving image data, and a packet 1c containing a piece of web content are input into the data transfer apparatus is considered below. In this example, it is assumed that the voice data is to be transferred with the highest priority, and the moving image data is to be transferred with the second highest priority. In addition, the plurality of buffer areas 2a to 2l are classified into buffer areas (2a to 2d) for the priority queuing (PQ), buffer areas (2e to 2h) for weighted-round-robin queuing (WRQ), and buffer areas (2i to 2l) for the best-effort queuing (BEQ). The highest priority is assigned to the buffer areas (2a to 2d) for the priority queuing (PQ), the second highest priority is assigned to the buffer areas (2e to 2h) for the weighted-round-robin queuing (WRQ), and the lowest priority is assigned to the buffer areas (2i to 2l) for the best-effort queuing (BEQ). A boundary value between the buffer areas (2a to 2d) for the priority queuing (PQ) and the buffer areas (2e to 2h) for the weighted-round-robin queuing (WRQ) is set in the register 4a. In addition, a boundary value between the buffer areas (2e to 2h) for the weighted-round-robin queuing (WRQ) and the buffer areas (2i to 2l) for the best-effort queuing (BEQ) is set in the register 4b.

In the example of FIG. 1, the voice attribute (i.e., the attribute of the voice data 1a) is associated with the buffer area 2a, the moving image attribute (i.e., the attribute of the moving image data 1b) is associated with the buffer area 2e, and the web attribute (i.e., the attribute of the web content 1c) is associated with the buffer area 2i.

In this case, the buffer control circuit 3 stores the packet containing the voice data 1a in the buffer area 2a, the packet containing the moving image data 1b in the buffer area 2e, and the packet containing the web content 1c in the buffer area 2i.

When it becomes possible to transmit packets, the selector 4c refers to the registers 4a and 4b, and determines the priorities of the plurality of buffer areas 2a to 2l. Then, the selector 4c confirms that a packet containing the voice data 1a is stored in the buffer area 2a to which the highest priority is assigned, and selects the buffer area 2a. When the selection result is sent from the selector 4c to the buffer control circuit 3, the buffer control circuit 3 outputs a packet stored in the buffer area 2a. That is, the voice data 1a is output first.

When the output of the voice data 1a is completed, the selector 4c confirms that no packet is stored in the buffer areas for the priority queuing (PQ), and searches for a packet stored in the buffer areas for the weighted-round-robin queuing (WRQ). Then, the selector 4c confirms that a packet containing the moving image data 1b is stored in the buffer area 2e, and selects the buffer area 2e. When the selection result is sent from the selector 4c to the buffer control circuit 3, the buffer control circuit 3 outputs a packet stored in the buffer area 2e. That is, the moving image data 1b is output.

When the output of the moving image data 1b is completed, the selector 4c confirms that no packet is stored in the buffer areas for the priority queuing (PQ) and the buffer areas for the weighted-round-robin queuing (WRQ), and searches for a packet stored in the buffer areas for the best-effort queuing (BEQ). Then, the selector 4c confirms that a packet containing the web content 1c is stored in the buffer area 2i, and selects the buffer area 2i. When the selection result is sent from the selector 4c to the buffer control circuit 3, the buffer control circuit 3 outputs a packet stored in the buffer area 2i. That is, the web content 1c is output.

As described above, packets input into the packet transfer apparatus are output in priority order. In addition, it is possible to dynamically change the partitioning of the buffer areas for the respective priorities. For example, it is possible to perform manipulation so as not to allocate a buffer area to the priority queuing (PQ), or to reduce the number of the buffer areas for the weighted-round-robin queuing (WRQ) and increase the number of the buffer areas for the best-effort queuing (BEQ). In order to raise the priority of the moving image data 1b, it is possible to include the buffer area 2e associated with the moving image data 1b in the buffer areas for the priority queuing (PQ). This can be realized by setting a boundary value in the register 4a, where the boundary value is a value indicating the boundary between the buffer area 2e and the buffer area 2f. That is, the priorities of transferred packets can be changed by merely changing the values in the registers 4a and 4b. Therefore, it is possible to realize priority control of packets according to an environment (such as a data transfer rate) which varies with time.

Hereinbelow, details of the embodiments of the present invention are explained. In the following explanations, the term “service” means transmission of a packet by a packet transfer apparatus.

[First Embodiment]

In the first embodiment, the packet transfer apparatus according to the present invention is used in a data transfer apparatus which transfers data from an input port to an output port.

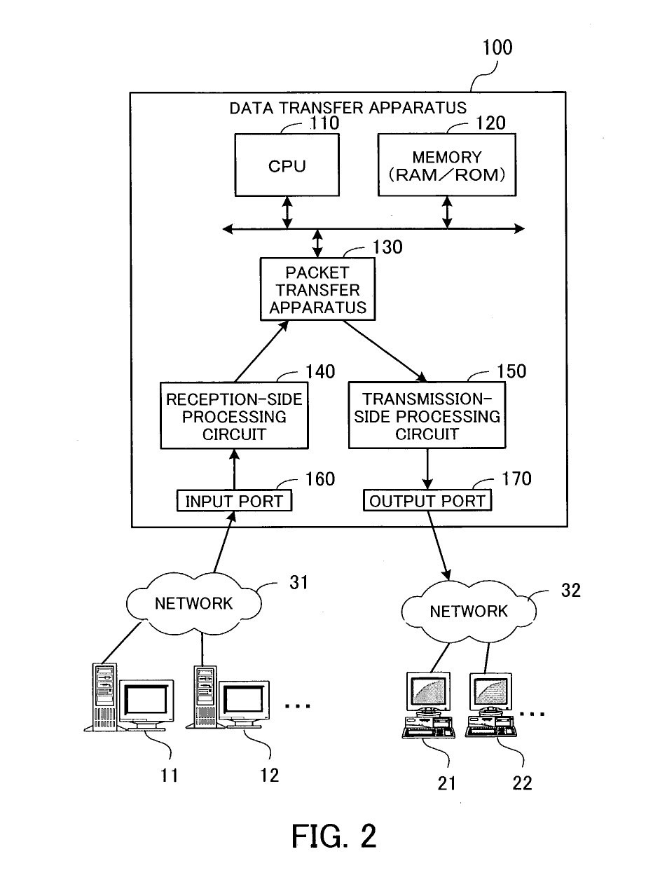

FIG. 2 is a diagram illustrating a system construction in the first embodiment of the present invention. The data transfer apparatus 100 as the first embodiment of the present invention is connected to a plurality of computers 11, 12, . . . through a network 31 and a plurality of computers 21, 22, . . . through a network 32. For example, the plurality of computers 11, 12, . . . are web servers which deliver content, and the plurality of computers 21, 22, . . . are personal computers of users who use the content.

The data transfer apparatus 100 has a function of transferring to the network 32 packets which are input into the data transfer apparatus 100 through the network 31. In order to realize this function, the data transfer apparatus 100 comprises a CPU (central processing unit) 110, a memory 120, a packet transfer apparatus 130, a reception-side processing circuit 140, a transmission-side processing circuit 150, an input port 160, and an output port 170.

The CPU 110 is a processor which executes data processing according to a description of a given program. The CPU 110 is connected to the memory 120 and the packet transfer apparatus 130. The CPU 110 acquires data from the packet transfer apparatus 130 or sets data in registers or the like in the packet transfer apparatus 130, based on a program or data stored in the memory 120. For example, the CPU 110 acquires a packet transfer rate from the packet transfer apparatus 130, and sets a boundary value in the packet transfer apparatus 130 according to the transfer rate, where the boundary value is a value indicating a boundary used for classifying buffer areas in the queue buffer.

The memory 120 is a semiconductor memory such as a RAM (random access memory) or ROM (read-only memory). In the memory 120, programs describing details of operations of the CPU 110 and data such as initial values of the registers in the packet transfer apparatus 130 are stored in advance.

The packet transfer apparatus 130 performs processing for transferring to the output port 170 packets which are input through the input port 160. In the processing for transferring packets by the packet transfer apparatus 130, the priorities of the packets are determined according to the attributes of the respective packets, and packets with higher priorities are preferentially transmitted.

The reception-side processing circuit 140 processes packets which are transmitted through the network 31 and input from the input port 160. Specifically, the reception-side processing circuit 140 receives packets which are input from the input port 160, and passes the packets to the packet transfer apparatus 130.

The transmission-side processing circuit 150 processes a packet which is to be transmitted from the output port 170 through the network 32. Specifically, the transmission-side processing circuit 150 transmits a packet passed from the packet transfer apparatus 130, from the input port 160 to the network 32.

The input port 160 is a communication port to which a cable for connection to the network 31 can be connected.

The output port 170 is a communication port to which a cable for connection to the network 32 can be connected.

Through the data transfer apparatus 100 having the above construction, packets are transferred from the network 31 to the network 32. For example, when a packet addressed to the computer 21 is output to the network 31 from the computer 11, the packet is input through the input port 160 into the data transfer apparatus 100. When the reception-side processing circuit 140 receives the packet, the reception-side processing circuit 140 confirms that the packet transfer apparatus 130 can store a new packet, and thereafter the reception-side processing circuit 140 passes the received packet to the packet transfer apparatus 130. The packet transfer apparatus 130 determines the attribute of the packet passed to the packet transfer apparatus 130. For example, the attribute is “image data,” “voice data,” “text data,” or the like. When the packet is an IP packet, it is possible to determine the attribute based on a value of an IP address, a TCP (Transmission Control Protocol) or UDP (User Datagram Protocol) port number, or the like.

The packet transfer apparatus 130 holds in the buffer the packet passed to the packet transfer apparatus 130, and performs scheduling of a transmission timing of the packet according to the attribute of the packet. At the transmission timing of the packet, the packet transfer apparatus 130 passes the packet to the transmission-side processing circuit 150. Then, the transmission-side processing circuit 150 outputs the packet addressed to the computer 21, to the network 32 through the output port 170.

Next, the functions of the packet transfer apparatus 130 are explained in detail below.

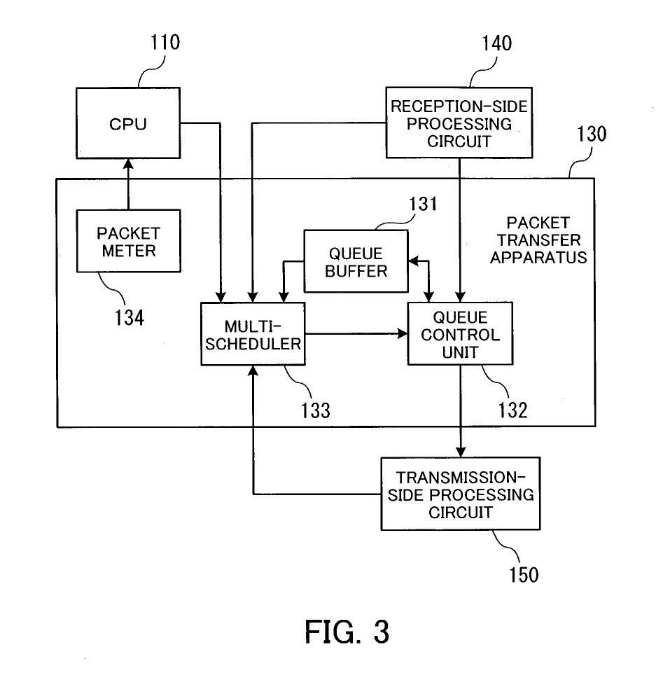

FIG. 3 is a block diagram illustrating the functions of the packet transfer apparatus. The packet transfer apparatus 130 comprises a queue buffer 131, a queue control unit 132, a multischeduler 133, and a packet meter 134.

The queue buffer 131 is connected to the queue control unit 132 and the multischeduler 133. The queue buffer 131 has a storage area for storing a packet to be transmitted. The storage area in the queue buffer 131 is partitioned into a plurality of buffer areas respectively corresponding to transmission requests. Each of the plurality of buffer areas is associated with one of the transmission requests, and packets corresponding to transmission requests are queued in the buffer areas associated with the transmission requests, respectively.

In addition, a service class, which indicates a priority, is set in each buffer area in the queue buffer 131. The definition of the service class of each buffer area is set in the multischeduler 133, and can be dynamically changed. In this example, one of the priority queuing (PQ), the weighted-round-robin queuing (WRQ), and the best-effort queuing (BEQ) is set as a service class of each buffer area. The priority of transmission of packets in each buffer area is determined according to the service class. The highest priority is assigned to the buffer areas for the priority queuing (PQ), the second highest priority is assigned to the buffer areas for the weighted-round-robin queuing (WRQ), and the lowest priority is assigned to the buffer areas for the best-effort queuing (BEQ).

The queue control unit 132 is connected to the reception-side processing circuit 140 and the transmission-side processing circuit 150, which are arranged outside the packet transfer apparatus 130. In addition, the queue control unit 132 is also connected to the queue buffer 131 and the multischeduler 133, which are arranged in the packet transfer apparatus 130. When the queue control unit 132 receives a packet from the reception-side processing circuit 140, the queue control unit 132 stores the packet in the queue buffer 131. At this time, the queue control unit 132 determines the type of the transmission request for the packet (e.g., discriminates between the image data, the voice data, the text data, and the like), and stores the packet in a buffer area corresponding to the determined type in the queue buffer 131. Thereafter, the queue control unit 132 acquires the packet from the queue buffer 131 in response to a signal from the multischeduler 133, and passes the packet to the transmission-side processing circuit 150.

The multischeduler 133 is connected to the CPU 110, the reception-side processing circuit 140, and the transmission-side processing circuit 150, which are arranged outside the packet transfer apparatus 130. In addition, the multischeduler 133 is also connected to the queue buffer 131 and the queue control unit 132, which are arranged in the packet transfer apparatus 130. The multischeduler 133 collects reception requests output from the reception-side processing circuit 140 and transmission requests output from the transmission-side processing circuit 150, and performs scheduling for determining the order in which the requests are to be processed. Specifically, the multischeduler 133 checks whether or not a packet is queued in each buffer area in the queue buffer 131, and performs scheduling based on the priority corresponding to the service class of each buffer area. Further, the multischeduler 133 performs service on a packet which is selected as a packet to be transmitted. That is, the multischeduler 133 sends a transmission request for the selected packet to the queue control unit 132.

In addition, the multischeduler 133 holds information on a definition of the service class of each buffer area in the queue buffer 131. Specifically, the multischeduler 133 holds two values (boundary values) indicating boundaries between storage areas corresponding to the respective service classes in the queue buffer 131. Thus, the queue buffer 131 is partitioned into three storage areas, and the queue buffer 131 has the buffer areas for the priority queuing (PQ), the buffer areas for the weighted-round-robin queuing (WRQ), and the buffer areas for the best-effort queuing (BEQ). The boundary values are supplied from the CPU 110 when the system is started up. Further, when the multischeduler 133 receives from the CPU 110 a request for update of the boundary values, the multischeduler 133 changes the boundary values in response to the request for the update.

The packet meter 134 is a circuit for checking whether or not packets are transferred in accordance with a profile which is preset, and monitors the operations of the elements in the packet transfer apparatus 130. In the profile, for example, the minimum transfer rate for each type of request is set. When transfer of packets does not comply with the profile, the packet meter 134 sends to the CPU 110 information (an alarm) indicating the noncompliance with the profile. For example, when the transfer rate which is set for requests for voice becomes equal to or lower than a predetermined value, communication by IP telephone becomes difficult. In this case, the packet meter 134 notifies the CPU 110 of the noncompliance with the profile, and prompts the CPU 110 to change the storage capacity for each service class in the queue buffer 131.

In the above packet transfer apparatus 130, the following processing is performed.

When the data transfer apparatus 100 is started up, the CPU 110 sets initial values in registers and the like in the packet transfer apparatus 130. Thus, boundary values are set in the multischeduler 133. Thereafter, when a packet is input into the data transfer apparatus 100 through the input port 160, the packet is transferred from the reception-side processing circuit 140 to the queue control unit 132 in the packet transfer apparatus 130. At this time, a reception request is passed by the reception-side processing circuit 140 to the multischeduler 133 in the packet transfer apparatus 130. When a space exists in a buffer area in the queue buffer 131 in which the packet is to be stored, the multischeduler 133 provides the queue control unit 132 with permission to receive the packet. In response to the permission, the queue control unit 132 queues the received packet in the buffer area corresponding to the type of the reception request in the queue buffer 131.

In addition, when the transmission-side processing circuit 150 becomes transmittable, the transmission-side processing circuit 150 outputs a transmission request to the multischeduler 133. In response to the transmission request, the transmission-side processing circuit 150 determines a packet to be transmitted, among at least one packet queued in the queue buffer 131. Specifically, the multischeduler 133 determines whether or not a packet is queued in each buffer area in the queue buffer 131 in decreasing order of the priority of the service class. In addition, the multischeduler 133 selects one of buffer areas corresponding to the highest priority in which at least one packet is queued, in accordance with a predetermined rule, and determines a packet which is first queued in the selected buffer area to be transmitted.

The multischeduler 133 notifies the queue control unit 132 of the selected buffer area. Then, the queue control unit 132 acquires the packet which is first queued in the notified buffer area, and passes the acquired packet to the transmission-side processing circuit 150. Thus, the packet is output by the transmission-side processing circuit 150 to the network 32.

At this time, the transfer rate for each type of packets is monitored by the packet meter 134. When the transfer rate does not comply with the preset profile, the packet meter 134 notifies the CPU 110 of the noncompliance to the profile. Then, the CPU 110 changes the boundary values which are set in the multischeduler 133 and indicate the partition of the queue buffer 131 for the service classes, so as to maintain the quality of service (QoS) in important communication. For example, the CPU 110 increases the transfer rate in the important communication by lowering the priority of the buffer areas other than buffer area or buffer areas which are used for the important communication.

Next, functions of the multischeduler 133 are explained in detail.

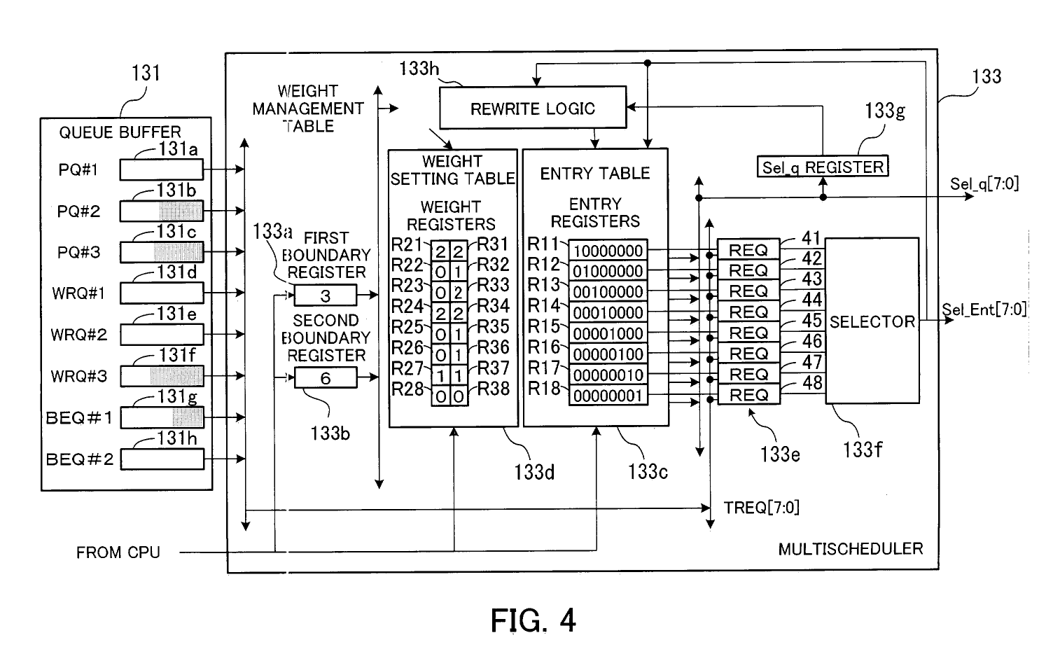

FIG. 4 is a block diagram illustrating a construction of the multischeduler. The multischeduler 133 comprises a first boundary register 133a, a second boundary register 133b, an entry table 133c, a weight setting table 133d, an entry determination unit 133e, a selector 133f, a queue selection (Sel_q) register 133g, and a rewrite logic 133h.

In the example of FIG. 4, the queue buffer 131 is partitioned into eight buffer areas 131a to 131h, and each of the buffer areas 131a to 131h is associated with a transmission request. In this example, it is assumed that each of the buffer areas 131a to 131h indicated in FIG. 4 is associated with a transmission request in communication in which the quality of service is more strongly required to be guaranteed (i.e., communication with higher priorities) than any other buffer area indicated in a lower portion of FIG. 4. In FIG. 4, transmission requests having identification numbers 7, 6, 5, . . . , 0 are associated with the buffer areas 131a to 131h, respectively.

A set of request signals TREQ[k:0], each of which indicates whether or not a transmission request is output, are input from the queue butter 131 to the multischeduler 133. The set of request signals TREQ[k:0] are output on a plurality of signal lines, the number of which is identical to the number of the transmission requests, and k is the maximum value of the identification numbers of the transmission requests. Since, in the example of FIG. 4, the queue buffer 131 is partitioned into the eight buffer areas 131a to 131h, and the number of the transmission requests is eight, k=7. A signal “1” is output on each signal line when a corresponding transmission request is output. In the case where the set of request signals TREQ[k:0] are active high signals, a signal corresponding to a buffer area becomes high while a packet is queued in the buffer area.

Specifically, a request signal TREQ[7] indicates whether or not a transmission request corresponding to the buffer area 131a exists, a request signal TREQ[6] indicates whether or not a transmission request corresponding to the buffer area 131b exists, a request signal TREQ[5] indicates whether or not a transmission request corresponding to the buffer area 131c exists, a request signal TREQ[4] indicates whether or not a transmission request corresponding to the buffer area 131d exists, a request signal TREQ[3] indicates whether or not a transmission request corresponding to the buffer area 131e exists, a request signal TREQ[2] indicates whether or not a transmission request corresponding to the buffer area 131f exists, a request signal TREQ[1] indicates whether or not a transmission request corresponding to the buffer area 131g exists, and a request signal TREQ[0] indicates whether or not a transmission request corresponding to the buffer area 131h exists. The set of request signals TREQ[7:0] are input into the entry determination unit 133e in the multischeduler 133.

Threshold values for classifying a plurality of entry registers R11 to R18 having respective priorities are set in the first boundary register 133a and the second boundary register 133b. That is, a processing schedule of transmission requests entered in the plurality of entry registers R11 to R18 is determined based on the values in the first boundary register 133a and the second boundary register 133b.

The first boundary register 133a holds the number of the final one of the buffer areas for the priority queuing (PQ) to which the highest priority is assigned, and the second boundary register 133b holds the number of the final one of the buffer areas for the weighted-round-robin queuing (WRQ) to which the second highest priority is assigned. In the example of FIG. 4, the first boundary register 133a holds “3” so that three top buffer areas 131a to 131c are used as the buffer areas for the priority queuing (PQ), and the second boundary register 133b holds “6” so that the fourth to sixth buffer areas 131d to 131f are used as the buffer areas for the weighted-round-robin queuing (WRQ). In this case, the seventh and eighth buffer areas 131g and 131h are used as the buffer areas for the best-effort queuing (BEQ).

In addition, a signal from the CPU 110 is supplied to each of the first boundary register 133a and the second boundary register 133b, and the values in the first boundary register 133a and the second boundary register 133b are updated with data supplied by the CPU 110.

The entry table 133c is a data storage area for controlling the order of output of packets from the buffer areas 131a to 131h in the queue buffer 131. The entry table 133c comprises entry registers R11 to R18, the number of which corresponds to the number of the buffer areas 131a to 131h. That is, in the example of FIG. 4, the eight entry registers R11 to R18 are provided in the entry table 133c.

Each of the eight entry registers R11 to R18 is a register having a plurality of bits the number of which corresponds to the number of transmission requests. That is, the number of the bits constituting each of the eight entry registers R11 to R18 is identical to the number of the buffer areas 131a to 131h. The identification numbers of the transmission requests are set in the entry registers R11 to R18 in accordance with the priority order of processing of the transmission requests. Hereinafter, each of the identification numbers set in the entry registers R11 to R18 is referred to as an entry. For example, in the case of the set of transmission signals TREQ[7:0], where the number of the transmission requests is eight, and higher priorities correspond to greater identification numbers, each of the entry registers R11 to R18 has eight bits. Each bit is associated with one of the identification numbers of the transmission requests. Specifically, in the initial state, the ith bit in the ith one of the entry registers R11 to R18 is set to “1,” i.e., “10000000,” “01000000,” “00100000,” “00010000,” “00001000,” “00000100,” “00000010,” and “00000001” are set in the entry registers R11 to R18, respectively. In FIG. 4, the initial state of the entry table 133c is indicated.

The entry registers R11 to R18 in the entry table 133c are classified into a group of entry registers for the priority queuing (PQ), a group of entry registers for the weighted-round-robin queuing (WRQ), and a group of entry registers for the best-effort queuing (BEQ). Since, in the example of FIG. 4, the first boundary register 133a holds “3” and the second boundary register 133b holds “6,” three top entry registers R11 to R13 belong to the group for the priority queuing (PQ), the fourth to sixth entry registers R14 to R16 belong to the group for the weighted-round-robin queuing (WRQ), and the seventh and eighth entry registers R17 and R18 belong to the group for the best-effort queuing (BEQ). The values set in the entry registers R11 to R18 can be exchanged only within each group. The grouping is dynamically changed according to the boundary values set in the first boundary register 133a and the second boundary register 133b.

The weight setting table 133d holds information for setting weights corresponding to the buffer areas 131a to 131h in the queue buffer 131. That is, when the weight setting table 133d is used, the transmission requests associated with the buffer areas 131a to 131h can be weighted corresponding to transfer rates required for the transmission requests. In the weight setting table 133d, weight registers R21 to R28 and initial-value registers R31 to R38 are provided, and registers indicated side by side in FIG. 4 are associated with each other. In addition, there are one-to-one correspondences between the weight registers R21 to R28 and the entry registers R11 to R18, and between the initial-value registers R31 to R38 and the entry registers R11 to R18.

That is, the values in the weight registers R21 to R28 are currently used values of the weights for the buffer areas in the queue buffer 131 which are indicated in the corresponding entry registers, and the values in the initial-value registers R31 to R38 are initial values of the weights for the buffer areas in the queue buffer 131 which are indicated in the corresponding entry registers, where the corresponding buffer areas are indicated in the entry registers R11 to R18. Therefore, when the values in the entry registers R11 to R18 are exchanged, the values in the weight registers R21 to R28 and the values in the initial-value registers R31 to R38 are also exchanged.

The weights in the weight registers R21 to R28 each indicate the number of consecutive service executions, i.e., the number of consecutive receptions of transmission requests without change of the priority order. For example, when the weight associated with an entry register is “0” at the time of service execution of a transmission request, the priority of the corresponding entry is changed to the final priority in a group of the search class to which the entry register belongs, immediately after the service execution. When the weight associated with an entry register is “1” or greater at the time of service execution of a transmission request, the weight is decreased by one every time a transmission request is executed, and the entry registers are not rewritten until the weight reaches “0.” That is, the priority is changed to the final priority in each group of the entry registers after transmission requests from an identical buffer area are consecutively executed. When the priority of the entry register is changed to the final priority, the value in the corresponding initial-value register is set in the corresponding weight register.

The entry determination unit 133e is a circuit for determining whether or not a packet is queued in each of the buffer areas 131a to 131h in the queue buffer 131 respectively corresponding to the values set in the entry registers R11 to R18. The entry determination unit 133e is constituted by a plurality of determination circuits 41 to 48, which are respectively associated with the entry registers R11 to R18.

The set of request signals TREQ[7:0] indicating whether or not a transmission request is queued in each buffer area in the queue buffer 131 and the values in the corresponding entry registers R11 to R18 are input into the determination circuits 41 to 48. Each of the determination circuits 41 to 48 determines whether or not a packet is queued in one of the buffer areas 131a to 131h in the queue buffer 131 corresponding to the value set in one of the entry registers R11 to R18 corresponding to the determination circuit. The determination results obtained by the determination circuits 41 to 48 are input into the selector 133f.

The selector 133f selects one of the entry registers R11 to R18 corresponding to one of the buffer areas 131a to 131h from which a packet is to be transmitted, based on the determination results by the determination circuits 41 to 48 in the entry determination unit 133e. Specifically, the selector 133f selects one of the entry registers R11 to R18 which has the highest priority, from among at least one of the entry registers R11 to R18 corresponding to at least one of the buffer areas 131a to 131h in which a packet is queued. Thus, a buffer area in the queue buffer 131 corresponding to the value set in the selected entry register is determined to be a buffer area from which a packet is to be transmitted.

A multibit selection signal Sel_Ent[7:0] indicating the selection result obtained by the selector 133f is passed to the rewrite logic 133h and the queue control unit 132 indicated in FIG. 3. The multibit selection signal Sel_Ent[7:0] has a plurality of bits, the number of which is identical to the number of the entry registers R11 to R18. In the example of FIG. 4, the number of the bits is eight. The respective bits of the multibit selection signal Sel_Ent[7:0] are associated with the entry registers R11 to R18, and are therefore arranged in the priority order. For example, the most significant bit (Sel_Ent[7]) of the multibit selection signal Sel_Ent[7:0] corresponds to the entry register R11 of the highest priority in the entry table 133c. In the multibit selection signal Sel_Ent[7:0], only one bit corresponding to the entry register selected as above is set to “1.” Thus, it is possible to recognize the selected entry register based on the multibit selection signal Sel_Ent[7:0].

The queue selection (Sel_q) register 133g is a register for indicating the contents of one of the entry registers R11 to R18 corresponding to a transmission request for which the service is executed. That is, the queue selection (Sel_q) register 133g indicates a buffer area in the queue buffer 131 from which a packet is to be transmitted. A queue selection signal Sel_q[7:0], which indicates a buffer area in the queue buffer 131 from which a packet is to be transmitted, is set in the queue selection (Sel_q) register 133g, and output to the queue control unit 132, which is indicated in FIG. 3. The value in the queue selection (Sel_q) register 133g is passed to the rewrite logic 133h.

The rewrite logic 133h is a circuit for rearranging the entry table 133c after a transmission request is executed. The rewrite logic 133h refers to the weight setting table 133d, and rearranges the entry table 133c only when the weight of the entry register corresponding to an accepted transmission request is “0.” When the weight of the entry register corresponding to the transmission request is not “0,” the rewrite logic 133h decrements the weight by one.

In the rearrangement of the entry table 133c, the entries are exchanged within entry registers of an identical service class so as to change the priority order. Specifically, the rewrite logic 133h recognizes an entry register corresponding to the accepted transmission request based on the multibit selection signal Sel_Ent[7:0], which is output from the selector 133f. At the same time, based on the queue selection signal Sel_q[7:0] output from the queue selection (Sel_q) register 133g, the rewrite logic 133h also recognizes a queue buffer in which a packet corresponding to the accepted transmission request is queued. In addition, the rewrite logic 133h recognizes the grouping of the buffer areas 131a to 131h in the queue buffer 131 corresponding to their priorities, based on the values in the first boundary register 133a and the second boundary register 133b.

Further, the rewrite logic 133h recognizes an entry register having the final priority in the group to which the entry register currently corresponding to the accepted transmission request belongs. Then, the rewrite logic 133h moves down the current value (entry) of the entry register currently corresponding to the accepted transmission request, to the entry register having the final priority in the group, and moves up each of at least one value (entry) currently set in at least one entry register to which at least one priority lower than the priority of the entry register currently corresponding to the accepted transmission request is assigned in the group, to an adjacent entry register to which a one-rank higher priority is assigned in the group.

Further, the rewrite logic 133h rearranges the weight setting table 133d corresponding to the rearrangement of the entry table 133c. Specifically, the values in the weight registers R21 to R28 in the weight setting table 133d are rearranged in the same manner as the rearrangement of the entry registers R11 to R18. At this time, the weight in the weight register associated with the entry register currently corresponding to the accepted transmission request is returned to the corresponding initial value.

The processing performed by the multischeduler 133 having the above construction is as follows.

When the data transfer apparatus 100 is powered on, the multischeduler 133 is initialized. In the initialization of the multischeduler 133, the CPU 110 sets values indicating the identification numbers of the buffer areas 131a to 131h in the queue buffer 131, in the entry registers R11 to R18, so as to define a priority order. In the example of FIG. 4, for easy understanding of the correspondences, the values in the entry registers R11 to R18 are set so that the identification numbers of the buffer areas 131a to 131h correspond to the priorities of the buffer areas 131a to 131h. That is, values “10000000,” “01000000,” “00100000,” “00010000,” “00001000,” “00000100,” “00000010,” and “00000001” are set in the entry registers R11 to R18, respectively. Alternatively, when eight transmission requests exist, and a required descending priority order of the buffer areas 131a to 131h is the buffer area 131d, the buffer area 131f, the buffer area 131h, . . . , values “00010000,” “00000100,” “00000001,” . . . are set in the entry registers R11 to R18, respectively.

Next, the CPU 110 assigns predetermined weights to the entry registers R11 to R18. The assignment of the weights is realized by setting the initial values of the weights in the weight registers R21 to R28 in the weight setting table 133d.

After the initialization is completed, the multischeduler 133 performs scheduling of the transmission requests in accordance with the following sequences.

(1) The multischeduler 133 determines at least one entry register corresponding to at least one buffer area each of which outputs a transmission request. For example, when a plurality of transmission requests are input from the queue buffer 131 into the multischeduler 133, the entry determination unit 133e compares the entry registers R11 to R18 and the set of request signals TREQ[7:0]. Thus, the entry determination unit 133e outputs a set of entry signals Ent_Sig[i:0] which indicate which entry registers correspond to the plurality of transmission requests, where i is a natural number indicating the number of the all entry registers.

(2) The multischeduler 133 determines a transmission request which is to be executed. That is, the selector 133f determines which transmission request is to be executed, and outputs a multibit selection signal Sel_Ent[7:0] indicating the transmission request which is to be executed. Thus, the selector 133f uniquely determines an entry signal corresponding to the transmission request which is to be executed, from among the set of entry signals Ent_Sig[i:0] which are respectively output corresponding to the entry registers R11 to R18. At this time, the selector 133f outputs a multibit selection signal Sel_Ent[i:0] indicating the entry register corresponding to the transmission request which is to be executed.

(3) The value of the entry register corresponding to the transmission request to be executed is output. That is, only one bit in the multibit selection signal Sel_Ent[i:0] which indicates the transmission request selected by the selector 133f is high (“1”). The multibit selection signal Sel_Ent[i:0] is input into the entry table 133c as an enable signal of the entry registers R11 to R18. Then, data (a bit series indicating an identification number of the transmission request to be executed) in the entry register designated by the enable signal (corresponding to the high (“1”) bit) is output from the entry table 133c as a queue selection signal Sel_q[k:0].

(4) The entry table 133c and the weight setting table 133d are rearranged. The queue selection signal Sel_q[k:0] is temporarily stored in the queue selection (Sel_q) register 133g. Thereafter, the rewrite logic 133h refers to the value in the weight register corresponding to the entry register related to the currently executed service (i.e., the entry register 52 designated by the queue selection signal).

(4-1) When the value in the weight register is “0” the entry table 133c and the weight setting table 133d are rearranged. In the rearrangement of the entry table 133c, the value of the queue selection signal Sel_q[k:0] is written in one of the entry registers R11 to R18. At this time, each of at least one value currently set in at least one entry register to which at least one priority lower than the priority of the entry register related to the currently executed service is assigned in the group is moved up to an adjacent entry register to which a one-rank higher priority is assigned. In addition, the rewrite logic 133h moves down the value of the currently used entry register, to the entry register to which the final priority is assigned in the group. The entry register to which the final priority in each group is assigned is an entry register indicated in the first boundary register 133a or the second boundary register 133b, or the entry register at the bottom. At this time, the values in the weight registers R21 to R28 are also rearranged corresponding to the rearrangement of the entry registers R11 to R18.

(4-2) When the value in the weight register is “1” or greater, the value in the weight register is decremented by one, and the entry table 133c and the weight setting table 133d are not rearranged. Thus, until service executions corresponding to the weight which is set for each transmission request are completed, the priority of the transmission request is not lowered. For example, when the weight is “2,” the priority is lowered after two service executions are completed.

Next, an internal construction of a determination circuit is explained below.

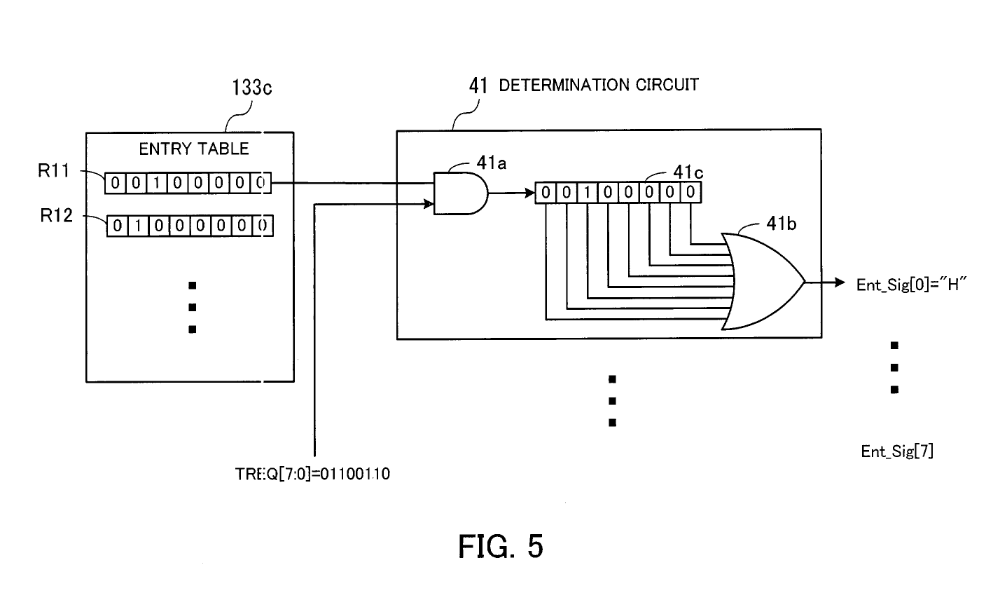

FIG. 5 is a diagram illustrating an example of the determination circuit. In FIG. 5, a construction of the determination circuit 41 corresponding to the entry register R11 is illustrated. The determination circuit 41 comprises an AND circuit 41a and a BITOR circuit 41b. The value in the entry register R11 and the set of request signals TREQ[7:0] are input into the AND circuit 41a, and a bit series 41c output from the AND circuit 41a is input into the BITOR circuit 41b. The BITOR circuit 41b outputs an entry signal Ent_Sig[0].

In the AND circuit 41a in the determination circuit 41, a bitwise logical product of the entry register R11 and the set of request signals TREQ[7:0] is output as the bit series 41c. In the entry register R11, only a bit indicating an identification number of a transmission request corresponding to the entry register is “1,” and the other bits are “0.” In addition, in the set of request signals TREQ[7:0], at least one bit corresponding to at least one transmission request currently output is set to “1.” Therefore, only when a transmission request corresponding to the entry register R11 is output, a bit series 41c in which the bit corresponding to the transmission request is “1” is output.

In the BITOR circuit 41b, a logical sum of the bits of the bit series 41c is output as the entry signal Ent_Sig[0]. Therefore, when the bit series 41c include at least one “1” bit, the entry signal Ent_Sig[0] becomes high (in the case where the high level signal indicates “1”).

In the example of FIG. 5, data “00100000” indicating a transmission request with an identification number “5” is set in the entry register R11 in the entry table 133c. In addition, the values of the set of request signals TREQ[7:0] are “01100110.” These values of the set of request signals TREQ[7:0] indicate that transmission requests corresponding to the identification numbers “6,” “5,” “2,” and “1” are currently output. That is, the transmission request corresponding to the entry “00100000,” which is set in the entry register R11 in the entry table 133c, is currently output. Therefore, a bit series 41c, in which the third bit is “1,” is output as a result of logical AND calculation by the AND circuit 41a. The BITOR circuit 41b calculates a logical sum of the bits of the bit series 41c, and outputs the high level signal “H” (indicating “1”) as the entry signal Ent_Sig[0].

Although only the determination circuit 41 corresponding to the entry register R11 is illustrated in FIG. 5, the other determination circuits 42 to 48 have a similar construction. Therefore, the determination circuits 42 to 48 respectively output entry signals Ent_Sig[1], Ent_Sig[2], . . . Ent_Sig[7] by similar processing. Thus, the position of an entry register corresponding to a transmission request currently output is indicated by a high (“1”) signal in the bit series of an entry signal Ent_Sig[7:0].

Next, a construction of the selector 133f is explained in detail.

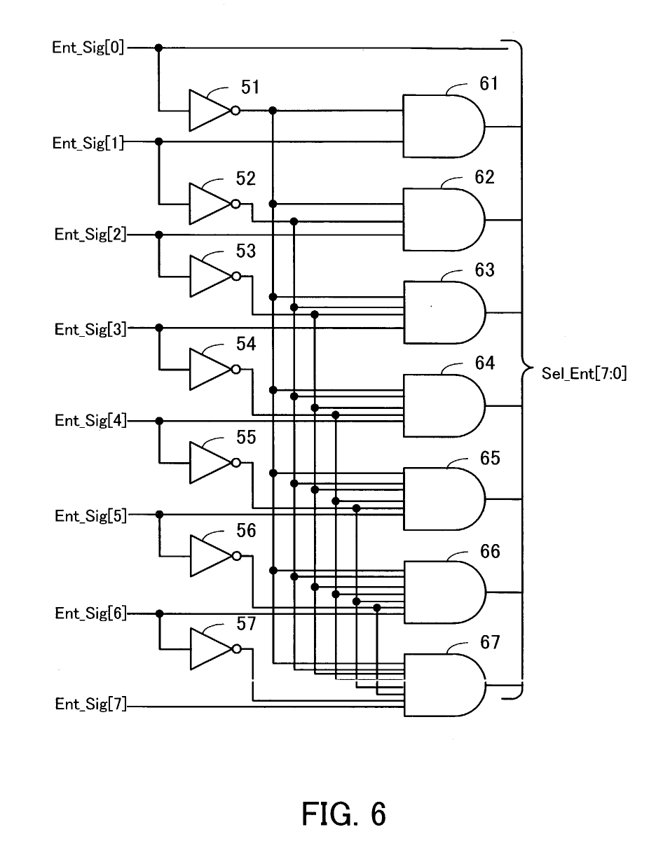

FIG. 6 is a diagram illustrating the construction of the selector. The selector 133f can be constituted by NOT circuits 51 to 57 and AND circuits 61 to 67.

The entry signal Ent_Sig[0] is output as a selection signal Sel_Ent[0] without modification. The high (“1”) state of the selection signal Sel_Ent[0] indicates that the entry register R11 is selected.

The entry signal Ent_Sig[0] is also input into the AND circuits 61 to 67 through the NOT circuit 51. In addition, the entry signal Ent_Sig[1] is also input into the AND circuit 61, and the output of the AND circuit 61 is a selection signal Sel_Ent[1]. Thus, the selection signal Sel_Ent[1] becomes high (“1”) only when the entry signal Ent_Sig[0] is low (“0”) and the selection signal Ent_Sig[1] is high (“1”). The high (“1”) state of the selection signal Sel_Ent[1] indicates that the entry register R12 is selected.

The entry signal Ent_Sig[1] is also input into the AND circuits 62 to 67 through the NOT circuit 52. In addition, the entry signal Ent_Sig[2] is also input into the AND circuit 62, and the output of the AND circuit 62 is a selection signal Sel_Ent[2]. Thus, the selection signal Sel_Ent[2] becomes high (“1”) only when the selection signal Sel_Ent[0] and the selection signal Sel_Ent[1] are low (“0”) and the entry signal Ent_Sig[2] is high (“1”). The high (“1”) state of the selection signal Sel_Ent[2] indicates that the entry register R13 is selected.

Likewise, the entry signal Ent_Sig[3] is input into the AND circuit 63, the entry signal Ent_Sig[4] is input into the AND circuit 64, the entry signal Ent_Sig[5] is input into the AND circuit 65, the entry signal Ent_Sig[6] is input into the AND circuit 66, and the entry signal Ent_Sig[7] is input into the AND circuit 67. In addition, the entry signal Ent_Sig[2] is input into the AND circuits 63 to 67 through the NOT circuit 53, the entry signal Ent_Sig[3] is input into the AND circuits 64 to 67 through the NOT circuit 54, the entry signal Ent_Sig[4] is input into the AND circuits 65 to 67 through the NOT circuit 55, the entry signal Ent_Sig[5] is input into the AND circuits 66 and 67 through the NOT circuit 56, and the entry signal Ent_Sig[6] is input into the AND circuit 67 through the NOT circuit 57.

Therefore, each of the selection signals Sel_Ent[1], Sel_Ent[2], Sel_Ent[3], Sel_Ent[4], Sel_Ent[5], Sel_Ent[6], and Sel_Ent[7] can become high (“1”) only when all of one or more selection signals corresponding to a priority or priorities higher than the priority of each of the selection signals are low (“0”). In other words, when one of the selection signals is high (“1”), all of one or more selection signals corresponding to a priority or priorities lower than the priority of the one of the selection signals are low (“0”).

Thus, in the multibit selection signal Sel_Ent[7:0], only a bit corresponding to an entry register to which the highest priority is assigned among one or more entry registers corresponding to one or more transmission requests which are currently output is high (“1”).

Next, processing for rearranging data in the entry table 133c and the weight setting table 133d by the rewrite logic 133h is explained in detail.

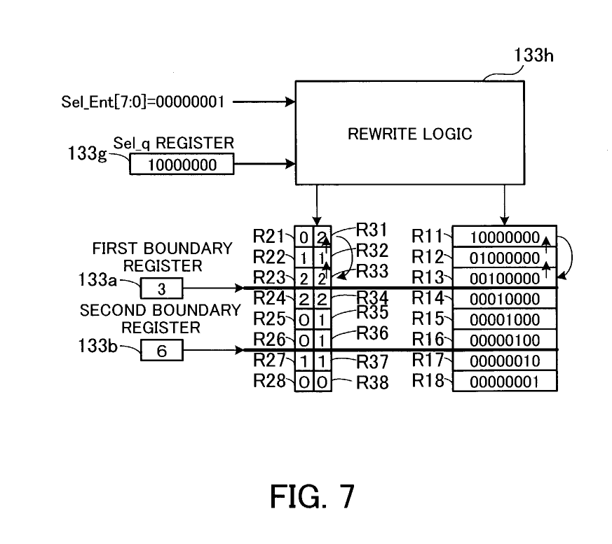

FIG. 7 is a conceptual diagram illustrating rearrangement processing by the rewrite logic. In the example of FIG. 7, a set of values “00000001” are output as the multibit selection signal Sel_Ent[7:0], and indicate that the entry register R11 having the highest priority is selected from among the entry registers R11 to R18. In addition, a set of values “10000000,” which indicate a transmission request having an identification number “7,” are set in the queue selection (Sel_q) register 133g. That is, a packet corresponding to this transmission request is queued in the buffer area 131a in the queue buffer 131.

Then, the rewrite logic 133h refers to the weight register R21 corresponding to the entry register R11. In the example of FIG. 7, “0” is set in the weight register R21. Therefore, the rewrite logic 133h determines that rearrangement of the entry table 133c and the weight setting table 133d is necessary. Thus, the rewrite logic 133h moves up the current entry of the entry register R12 to the entry register R11, and the current entry of the entry register R13 to the entry register R12. In addition, the rewrite logic 133h sets the contents of the queue selection (Sel_q) register 133g (the current entry of the entry register R11) in the entry register R13 which is indicated in the first boundary register 133a.

Further, the rewrite logic 133h moves up the current value of the weight register R22 to the weight register R21, the current value of the initial-value register R32 to the initial-value register R31, the current value of the weight register R23 to the weight register R22, and the current value of the initial-value register R33 to the initial-value register R32. In addition, the rewrite logic 133h moves down the current value of the initial-value register R31 to the initial-value register R33, and the current value of the initial-value register R33 to the weight register R23, where the value set in the weight register R23 is the initial value of the weight for a transmission request corresponding to the entry of the entry register R13.

As described above, the entry table 133c and the weight setting table 133d are rearranged. In the first embodiment, data in an entry register corresponding to a currently executed transmission request is moved down at most to an entry register indicated by a boundary value, and is not moved down beyond the boundary value.

Next, processing performed by the rewrite logic 133h in the case where a weight equal to or greater than one is set for an executed transmission request is explained.

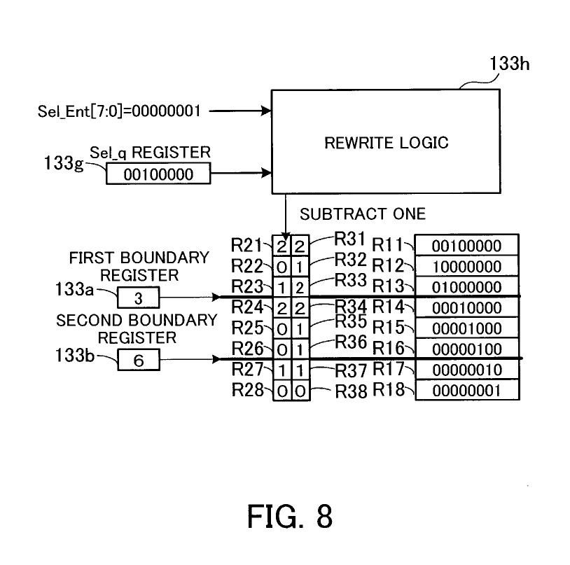

FIG. 8 is a conceptual diagram illustrating processing for update of a weight which is set for a transmission request. In the example of FIG. 8, a set of values “00000001” are output as the multibit selection signal Sel_Ent[7:0], and indicate that the entry register R11 to which the highest priority is assigned is selected from among the entry registers R11 to R18. In addition, a set of values “00100000,” which indicate a transmission request having the identification number “5” (the third highest priority), are set in the queue selection (Sel_q) register 133g. In this case, at least one packet corresponding to the transmission request is queued in the buffer area 131c in the queue buffer 131. Further, in the example of FIG. 8, “2” is set in the weight register R21 as a weight for the selected transmission request.

Since the weight in the weight register R21 is greater than one, the rewrite logic 133h determines that rearrangement of the entry table 133c and the weight setting table 133d is unnecessary. In addition, the rewrite logic 133h decrements the weight in the weight register R21 by one. Thus, the weight in the weight register R21 becomes “1.”

As described above, when a weight value greater than one is assigned to a transmission request from a buffer area, at least one further transmission request from the same buffer area can be consecutively executed by decrementing the weight value while maintaining a high priority. In addition, since the priority (i.e., the position in the entry table 133c) is lowered after service execution of a transmission request when the weight value is “0,” it is possible to prevent complete stoppage of service execution of other transmission requests.

Next, a sequence of processing performed by the rewrite logic 133h is explained.

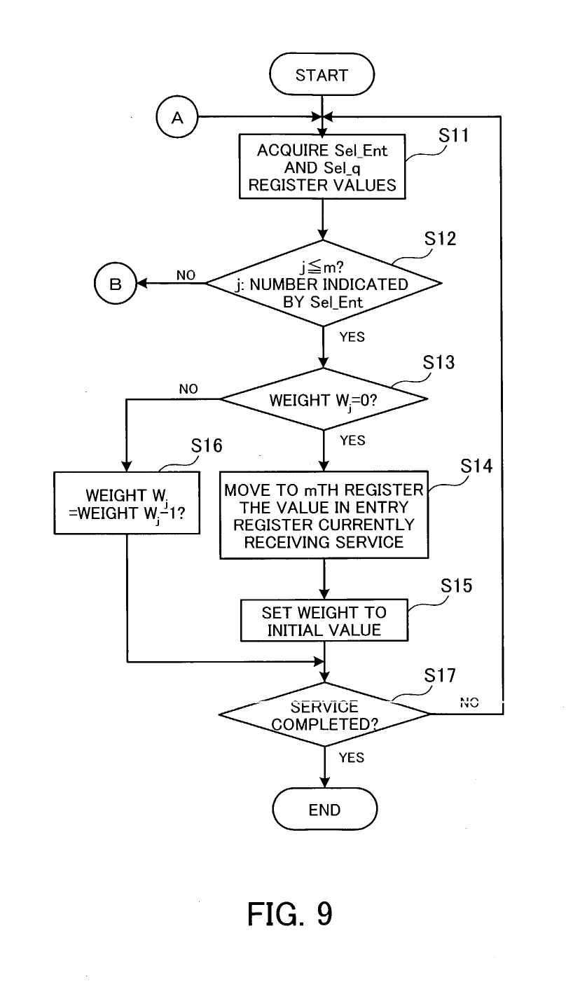

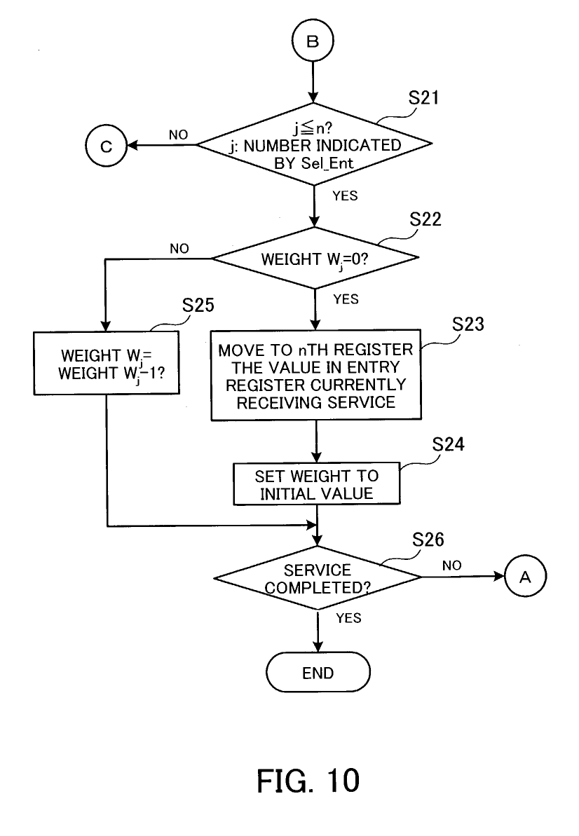

FIG. 9 is a first flow diagram indicating a sequence of processing performed by the rewrite logic 133h. The sequence of processing indicated in FIG. 9 is explained below step by step.

[Step S11] The rewrite logic 133h acquires a multibit selection signal Sel_Ent[7:0] and values set in the queue selection (Sel_q) register 133g.

[Step S12] The rewrite logic 133h determines whether or not a number indicated by the multibit selection signal Sel_Ent[7:0] is equal to or smaller than m, where j is a number indicating an entry register, m is the value set in the first boundary register, and j and m are each an integer equal to or greater than zero. When yes is determined in step S12, the operation goes to step S13. When no is determined in step S12, the operation goes to step S21 in FIG. 10.

[Step S13] The rewrite logic 133h determines whether or not a weight Wj corresponding to the entry register indicated by the multibit selection signal Sel_Ent[7:0] is zero, where the weight Wj is a value set in a weight register corresponding to the jth entry register. When the weight Wj is zero, the operation goes to step S14. When the weight Wj is not zero, the operation goes to step S16.

[Step S14] The rewrite logic 133h moves down data indicating a currently executed transmission request and being set in an entry register, to the mth entry register data. That is, the rewrite logic 133h rearranges the entry table 133c and the weight setting table 133d.

[Step S15] The rewrite logic 133h sets an initial value of the weight for the currently executed transmission request, in a weight register corresponding to the mth entry register, in which the data indicating the currently executed transmission request is set by the rearrangement. Thereafter, the operation goes to step S17.

[Step S16] When the weight Wj is equal to or greater than one, the rewrite logic 133h subtracts one from the weight Wj to obtain an updated value of the weight Wj, and sets the updated value as the weight Wj.

[Step S17] The rewrite logic 133h determines whether or not the service execution is completed. When yes is determined in step S17, the sequence of FIG. 9 is completed. When no is determined in step S17, the operation goes to step S11.

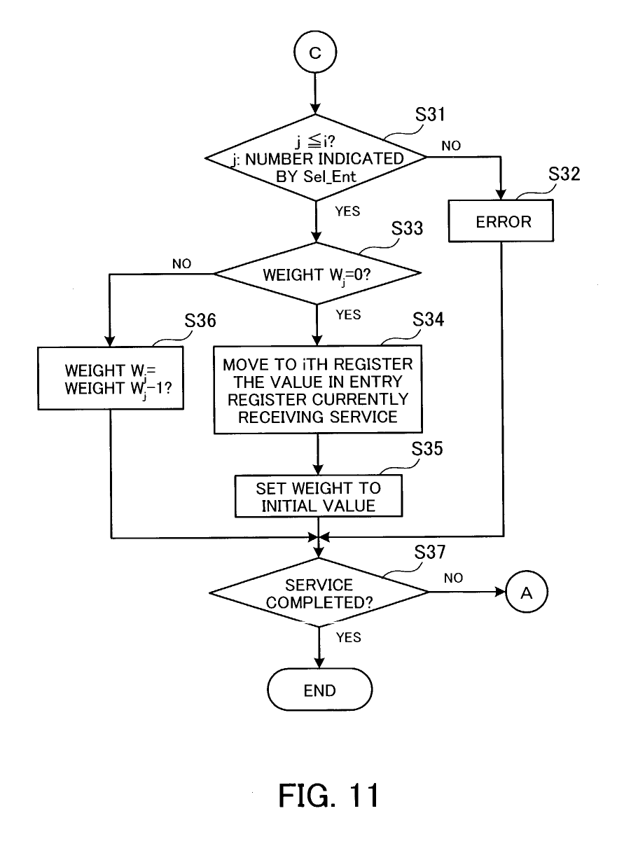

FIG. 10 is a second flow diagram indicating a sequence of processing performed by the rewrite logic. The sequence of processing indicated in FIG. 10 is explained below step by step.

[Step S21] The rewrite logic 133h determines whether or not the number j indicated by the multibit selection signal Sel_Ent[7:0] is equal to or smaller than n, where n is the value in the second boundary register and an integer equal to or smaller than zero. When yes is determined in step S21, the operation goes to step S22. When no is determined in step S22, the operation goes to step S31 in FIG. 11.

[Step S22] The rewrite logic 133h determines whether or not the weight Wj corresponding to the entry register indicated by the multibit selection signal Sel_Ent[7:0] is zero. When the weight Wj is zero, the operation goes to step S23. When the weight Wj is not zero, the operation goes to step S25.

[Step S23] The rewrite logic 133h moves down data indicating a currently executed transmission request and being set in an entry register, to the nth entry register.

[Step S24] The rewrite logic 133h sets an initial value of the weight for the currently executed transmission request, in a weight register corresponding to the nth entry register, in which the data indicating the currently executed transmission request is set by the rearrangement. Thereafter, the operation goes to step S26.

[Step S25] When the weight Wj is equal to or greater than one, the rewrite logic 133h subtracts one from the weight Wj to obtain an updated value of the weight Wj, and sets the updated value as the weight Wj.

[Step S26] The rewrite logic 133h determines whether or not the service execution is completed. When yes is determined in step S26, the sequence of FIG. 10 is completed. When no is determined in step S26, the operation goes to step S11 in FIG. 9.

FIG. 11 is a third flow diagram indicating a sequence of processing performed by the rewrite logic. The sequence of processing indicated in FIG. 11 is explained below step by step.

[Step S31] The rewrite logic 133h determines whether or not the number j indicated by the multibit selection signal Sel_Ent[7:0] is equal to or smaller than i, where i is the total number of the entry registers and an integer equal to or greater than zero. When yes is determined in step S31, the operation goes to step S33. When no is determined in step S31, the operation goes to step S32.

[Step S32] The rewrite logic 133h executes error processing, and then the operation goes to step S37.

[Step S33] The rewrite logic 133h determines whether or not the weight Wj corresponding to the entry register indicated by the multibit selection signal Sel_Ent[7:0] is zero. When the weight Wj is zero, the operation goes to step S34. When the weight Wj is not zero, the operation goes to step S36.

[Step S34] The rewrite logic 133h moves down data indicating a currently executed transmission request and being set in an entry register, to the ith entry register data.

[Step S35] The rewrite logic 133h sets an initial value of the weight for the currently executed transmission request, in a weight register corresponding to the ith entry register, where the data indicating the currently executed transmission request is set in the ith entry register by the rearrangement. Thereafter, the operation goes to step S37.

[Step S36] When the weight Wj is equal to or greater than one, the rewrite logic 133h subtracts one from the weight Wj to obtain an updated value of the weight Wj, and sets the updated value as the weight Wj.

[Step S37] The rewrite logic 133h determines whether or not the service execution is completed. When yes is determined in step S37, the sequence of FIG. 11 is completed. When no is determined in step S37, the operation goes to step S11 in FIG. 9.

As explained above, the priorities of transmission requests are rearranged within the sections partitioned with the boundary values, according to service executions of the transmission requests. For example, packets queued in the buffer areas 131a to 131c for the priority queuing (PQ) can receive service according to transmission requests for the packets with higher priority than packets queued in the other buffer areas 131d to 131h.

In addition, packets queued in the buffer areas 131d to 131f for the weighted-round-robin queuing (WRQ) can receive service according to transmission requests for the packets only when no packet waiting for transmission is queued in the buffer areas 131a to 131c for the priority queuing (PQ), and the packets queued in the buffer areas 131d to 131f for the weighted-round-robin queuing (WRQ) can receive service according to transmission requests for the packets with higher priority than packets queued in the buffer areas 131g and 131h for the best-effort queuing (BEQ).

Further, packets queued in the buffer areas 131g and 131h for the best-effort queuing (BEQ) can receive service according to transmission requests for the packets only when no packet waiting for transmission is queued in the buffer areas 131a to 131f for the priority queuing (PQ) and the weighted-round-robin queuing (WRQ).

When packets for communication in which a predetermined quality level is required to be maintained are queued in the buffer areas 131a to 131c for the priority queuing (PQ), and the above priority control operations are performed, the communication can be performed at the required quality level without influence of traffic of the packets queued in the buffer areas 131d to 131h for the weighted-round-robin queuing (WRQ) and the best-effort queuing (BEQ). For example, currently, use of IP telephone is widely spreading. In the IP telephone, voice data are required to be transmitted on a real-time basis. Therefore, it is necessary to secure a data transfer rate above a certain level for transfer of the voice data in the IP telephone. When packets for IP telephone are queued in the buffer areas 131a to 131c for the priority queuing (PQ), it is possible to secure a data transfer rate above the predetermined quality level.

In order to enhance the data transfer efficiency in the data transfer apparatus 100, it is necessary to appropriately allocate the buffer areas 131a to 131h for the priority queuing (PQ), the weighted-round-robin queuing (WRQ), and the best-effort queuing (BEQ). For example, when a large number of buffer areas are allocated for the priority queuing (PQ), the quality of communication can be secured. However, communication corresponding to the weighted-round-robin queuing (WRQ) and the best-effort queuing (BEQ) is likely to be clogged. Alternatively, when a small number of buffer areas are allocated for the priority queuing (PQ), the quality of communication cannot be secured.

According to the construction of the first embodiment, the storage capacities of the multischeduler 133 for the respective priorities can be changed by merely changing the values in the first boundary register 133a and the second boundary register 133b. Specifically, in the multischeduler 133 illustrated in FIG. 4, the CPU 110 can rewrite the values in the first boundary register 133a and the second boundary register 133b, and the rewrite logic 133h refers to the first boundary register 133a and the second boundary register 133b, and rearranges the entry table 133c and the weight setting table 133d. Thus, it is possible to change the values in the first boundary register 133a and the second boundary register 133b according to the packet transfer condition in the data transfer apparatus 100, and appropriately allocate the storage capacities of the queue buffer 131 for the priority queuing (PQ), the weighted-round-robin queuing (WRQ), and the best-effort queuing (BEQ).

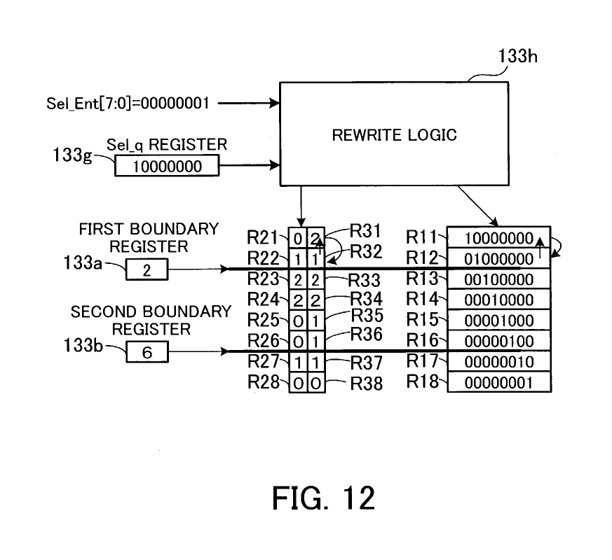

FIG. 12 is a conceptual diagram illustrating an example of the change of the boundary values. In the example of FIG. 12, the value of the first boundary register 133a is changed from “3” to “2” after the processing indicated in FIG. 8.

When the value in the first boundary register 133a is changed, the CPU 110 rearranges the entry table 133c and the weight setting table 133d. Specifically, the CPU 110 determines the number of the buffer areas for each service class and the priorities (service classes) of the buffer areas 131a to 131h in the queue buffer 131, where the buffer areas 131a to 131h are arranged in the priority order. In the example of FIG. 12, the buffer areas 131a and 131b are allocated for storing packets for the priority queuing (PQ), the buffer areas 131c to 131f are allocated for storing packets for the weighted-round-robin queuing (WRQ), and buffer areas 131g and 131h are allocated for storing packets for the best-effort queuing (BEQ).

At this time, two entry registers R11 and R12 are used as entries for transmission requests for packets stored in the buffer areas 131a and 131b for packets for the priority queuing (PQ). The transmission requests having the identification numbers “7” (“10000000”) and “6” (“01000000”) can be set in the entry registers R11 and R12. As illustrated in FIG. 8, before the change of the value in the first boundary register 133a, the identification number “5” (“00100000”) is set in the entry register R11. Therefore, when the value in the first boundary register 133a is changed, the identification number “5” (“00100000”) in the entry register R11 is moved down to the entry register R13, and the sets of values held in the entry registers R12 and R13 before the change of the value in the first boundary register 133a are respectively moved up to the entry registers R11 and R12.

In the example of FIG. 12, a set of values “00000001,” which indicates selection of the entry register R11 having the highest priority, is output as the multibit selection signal Sel_Ent[7:0]. In addition, a set of values “10000000,” which indicates a transmission request of the identification number “7” (corresponding to the highest priority), is set in the queue selection (Sel_q) register 133g. Packets corresponding to the above transmission request are queued in the buffer area 131a in the queue buffer 131. In addition, in the example of FIG. 12, “0” is set in the weight register R21 as a weight for the selected transmission request.

Since the value in the weight register R21 is “0,” the rewrite logic 133h rearranges the entry table 133c and the weight setting table 133d. In the rearrangement, data “10000000” and “01000000” as the entries of the entry registers R11 and R12 are exchanged. In addition, the weight “1” set in the weight register R22 is moved up to the weight register R21, and the weight “1” set in the initial-value register R32 is moved up to the initial-value register R31. Further, an initial value “2” of the weight for the transmission request corresponding to the data “10000000” is set in the weight register R22 and the initial-value register R32.

As described above, the allocation of the storage area in the queue buffer 131 for each service class can be dynamically changed corresponding to the change of the value in the first boundary register 133a. That is, the storage area in the queue buffer 131 can be optimumly allocated corresponding to the current situation of communication.

Next, a concrete example of the first embodiment is explained.

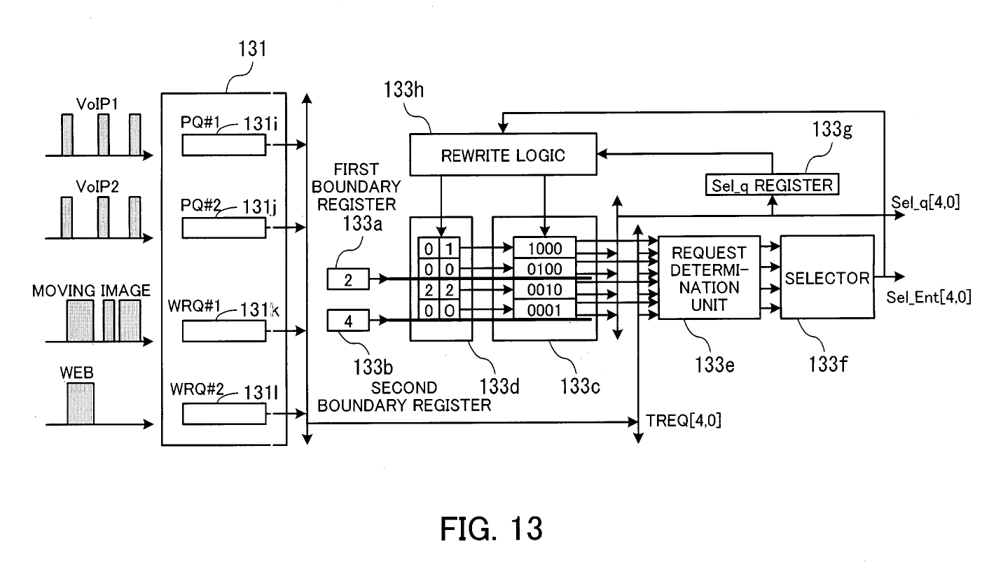

FIG. 13 is a diagram illustrating the concrete example of the first embodiment. In the example of FIG. 13, the queue buffer 131 is partitioned into four buffer areas 131i to 131l. Voice data VoLP1 for IP telephone are stored in the buffer area 131i, voice data VoLP2 for IP telephone are stored in the buffer area 131j, moving image data are stored in the buffer area 131k, and web content WEB is stored in the buffer area 131l.

In addition, “2” is set in the first boundary register 133a, and “4” is set in the second boundary register 133b. Therefore, packets in the buffer areas 131i and 131j are stored in accordance with the priority queuing (PQ), and packets in the buffer areas 131k and 131l are stored in accordance with the weighted-round-robin queuing (WRQ).

When the queue buffer 131 is used as above, packets for voice communication by IP telephone (for which real-time performance is most required) are stored in the buffer areas for the priority queuing (PQ), packets of moving image data such as video data are stored in a buffer area for the weighted-round-robin queuing (WRQ), and packets which do not require high priority, such as packets for web browsing, are stored in a buffer area for the weighted-round-robin queuing (WRQ) to which a smaller weight is assigned. The types of the packets can be discriminated based on header information or the like in the packets.

When packets of voice, moving image, and web browsing are stored in the queue buffer 131, and concurrently transmission requests are input into the multischeduler 133, packets stored in the buffer areas for the priority queuing (PQ) are handled and transferred with higher priority than packets stored in the buffer areas for the weighted-round-robin queuing (WRQ) in accordance with the flow diagrams of FIGS. 9 to 11. The buffer areas PQ#1 and PQ#2 for the priority queuing are round-robined within the range determined by the value (=2) set in the first boundary register 133a. For example, after a packet output from the buffer area PQ#1 receives the service, a packet output from the buffer area PQ#2 receives the service. The same applications VoIP1 and VoIP2 can equally receive the service with higher priority than the other applications. Thus, it is possible to achieve stable voice quality in calls by the IP telephone.

In addition, since normally voice uses only a very narrow bandwidth (e.g., 8 to 64 kbps), often no packet exist in the buffer areas for voice packets. In such situation, no transmission request is output from the buffer areas PQ#1 and PQ#2, and service in response to a transmission request from the buffer areas WRQ#1 and WRQ#2 is executed. It is assumed that in order to give a higher priority to the moving image data, “2” is set as the initial value of the weight corresponding to the buffer area WRQ#1, and “0” is set as the initial value of the weight corresponding to the buffer area WRQ#2. In this case, when transmission requests are concurrently outputs from the buffer areas WRQ#1 and WRQ#2, the transmission requests from the buffer areas WRQ#1 and WRQ#2 are executed in proportions of 3:1. Thus, it is possible to transfer moving image data with higher priority than the web data.

Further, since “4” is set in the second boundary register 133b in the example of FIG. 13, no buffer area for the best-effort queuing (BEQ) exists. Alternatively, it is possible to use the buffer area 131l as a buffer area for the best-effort queuing (BEQ) so that the moving image data is necessarily transferred before the web data in the buffer area 131l. This configuration can be realized by setting “3” in the second boundary register 133b.

Processing for changing a boundary value so as to raise the priority of the moving image data is explained in detail. In the following explanations, it is assumed that normally image data are transferred with the priority of the weighted-round-robin queuing (WRQ).

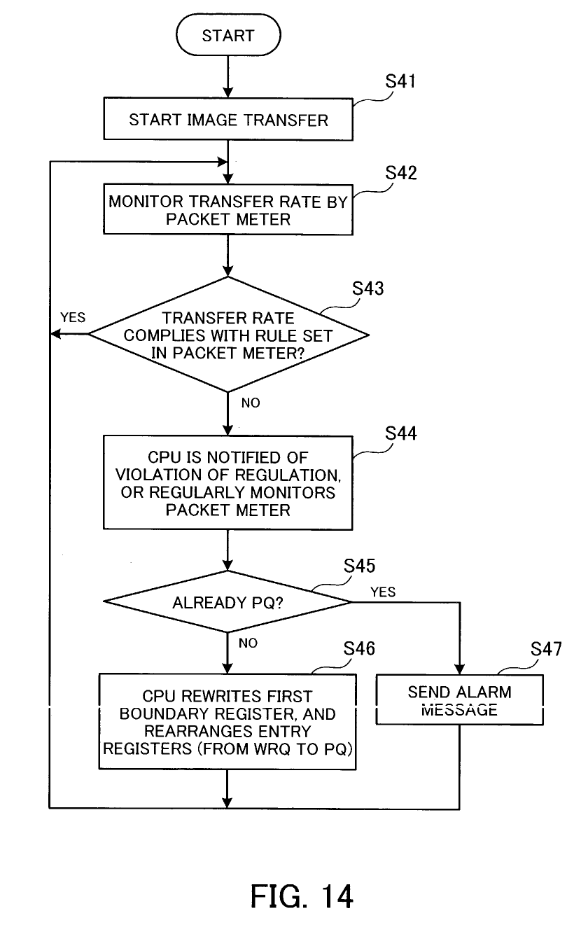

FIG. 14 is a flow diagram indicating a sequence of processing for changing a boundary value. The sequence of processing indicated in FIG. 14 is explained below step by step.

[Step S41] The data transfer apparatus 100 starts image transfer.

[Step S42] The packet meter 134 measures the transfer rate, and monitors the situation related to the transfer rate.

[Step S43] The packet meter 134 determines whether or not the transfer rate complies with a rule, which is preset in the packet meter 134. When yes is determined in step S43, the operation goes to step S42. When no is determined in step S43, the operation goes to step S44.

[Step S44] The packet meter 134 notifies the CPU 110 of the violation of the rule. Alternatively, the CPU 110 can regularly monitor internal information in the packet meter 134, and detect the violation of the transfer-rate rule.

[Step S45] The CPU 110 determines whether or not the priority level of the image transfer corresponds to the priority queuing (PQ). When yes is determined in step S45, the operation goes to step S47. When no is determined in step S45, the operation goes to step S46.

[Step S46] The CPU 110 rewrites the first boundary register, and rearranges the entry registers. In the rewriting of the first boundary register, the value of the first boundary register is increased so that the priority level of a buffer area storing packets of image data is raised by one rank. That is, the priority level of the image data is changed from the weighted-round-robin queuing (WRQ) to the priority queuing (PQ). Therefore, it is possible to continue transfer of the image data at a transfer rate which complies with the rule. Thereafter, the operation goes to step S42.

[Step S47] The CPU 110 sends an alarm message to a user. Thereafter, the operation goes to step S42.

As described above, after the image transmission is started, the packet meter 134 continuously monitors the transfer rate in an image transfer queue. When a violation of the transfer-rate rule occurs, and transfer at only a low transfer rate is possible, the first boundary register 133a and the second boundary register 133b are rewritten so as to raise the rank of the image transfer. If the image transfer queue has already been assigned to the priority queuing (PQ), the software sends an alarm to the user at the time of the violation.

In a data transfer in which image transfer and other traffic are mixed, normally the boundary values are set so as to allow the service to the other traffic to some extent. However, when unexpected traffic occurs, for example, due to an interference with (attack on) the service or downloading of a great amount of data, and the service to the image transfer queue is prevented, noise appears on the screen, and the image quality deteriorates. In particular, when the above image transfer is related to a charged service, the above situation causes a serious problem. Therefore, in order to assign top priority to the image transfer in above situation, the priority level of the transmission requests for image data is raised to the priority queuing (PQ). Since the transmission requests corresponding to the priority queuing (PQ) are executed with higher priority than any other traffic, the above problem is solved.

[Second Embodiment]

In the second embodiment, the multischeduler is formed in a multidimensional construction. That is, a plurality of multischedulers are combined into a construction having a multiple stages so that more complex scheduling is enabled. For example, consider a data transfer apparatus having a plurality of input and output interfaces. At this time, it is assumed that priority control is required for each interface. In the priority control, packets input through an interface to which a high priority is assigned are preferentially transferred. In this case, a first scheduler for selecting an input/output interface and a second scheduler for controlling the priority order for each transmission request in each communication interface are necessary. In the second embodiment, scheduling of a data transfer apparatus having a plurality of input/output interfaces is enabled by arranging the multischeduler in multiple stages.

Details of the second embodiment are explained below.

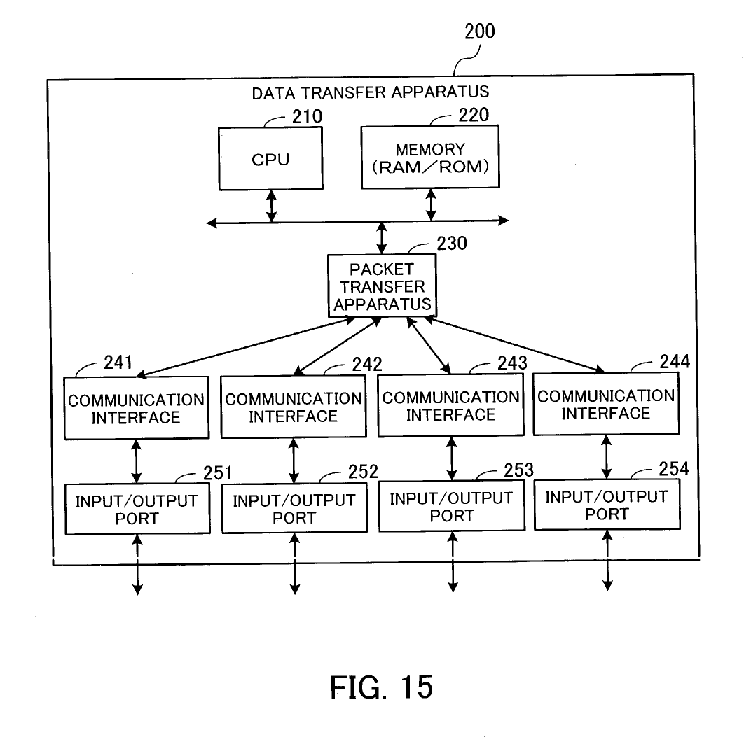

FIG. 15 is a block diagram illustrating a construction of the data transfer apparatus in the second embodiment of the present invention. The data transfer apparatus 200 in the second embodiment comprises a CPU 210, a memory 220, a packet transfer apparatus 230, a plurality of communication interfaces 241 to 244, and a plurality of input/output ports 251 to 254. The CPU 210 performs various types of data processing based on programs stored in the memory 220. For example, the CPU 210 refers to internal data of the packet transfer apparatus 230, and inputs data into the packet transfer apparatus 230. The memory 220 stores various programs and data such as initial values of registers in the packet transfer apparatus 230.

The packet transfer apparatus 230 receives packets from the plurality of communication interfaces 241 to 244, and performs scheduling of transmission timings of the packets. In addition, the packet transfer apparatus 230 outputs the respective packets to the plurality of communication interfaces 241 to 244.

The plurality of communication interfaces 241 to 244 transmit and receive packets through the plurality of input/output ports 251 to 254. Each of the plurality of input/output ports 251 to 254 comprises an input-side processing unit and an output-side processing unit. Each of the plurality of input/output ports 251 to 254 is a cable connection port connected to an external network.

The data transfer apparatus 200 having the plurality of communication interfaces as above can control priorities of the communication interfaces.

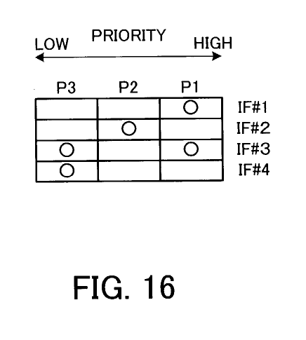

FIG. 16 is a diagram illustrating an example of a priority control service performed on packets which are input through the communication interfaces. In FIG. 16, priorities of packets passed from the respective communication interfaces 241 to 244 to the packet transfer apparatus 230 at a certain timing are indicated, where the communication interfaces 241 to 244 are respectively denoted by IF#1, IF#2, IF#3, and IF#4. In FIG. 16, priorities of buffer areas in a queue buffer for each communication interface are indicated in the lateral direction with P1, P2, and P3, which are respectively the highest, the second highest, and the lowest priorities.

In FIG. 16, a buffer area in which at least one packet passed from one of the plurality of communication interfaces 241 to 244 to the packet transfer apparatus 230 is queued is indicated by a blank circle (◯). In the example of FIG. 16, at least one packet from the communication interface 241 (IF#1) is queued in the buffer area of the priority P1, at least one packet from the communication interface 242 (IF#2) is queued in the buffer area of the priority P2, packets from the communication interface 243 (IF#3) are queued in the buffer areas of the priorities P1 and P3, and at least one packet from the communication interface 244 (IF#4) is queued in the buffer area of the priority P3.

In this case, the packets queued in the buffer areas of the priority P1 corresponding to the communication interfaces 241 (IF#1) and 243 (IF#3) are processed with higher priority than the other packets. At this time, the service to the communication interfaces 241 (IF#1) and 243 (IF#3) is evenly performed on a round-robin basis.

Next, the at least one packet from the communication interface 242 (IF#2) queued in the buffer area of the priority P2 receives the service.

Thereafter, the packets queued in the buffer areas of the priority P3 corresponding to the communication interfaces 243 (IF#3) and 244 (IF#4) are processed. At this time, the services to the communication interfaces 243 (IF#3) and 244 (IF#4) are evenly performed on a round-robin basis.

As described above, when packets input from a plurality of communication interfaces have an identical priority, the service to the plurality of communication interfaces is evenly performed on a round-robin basis. This processing can be realized by connecting multischedulers in multiple stages.

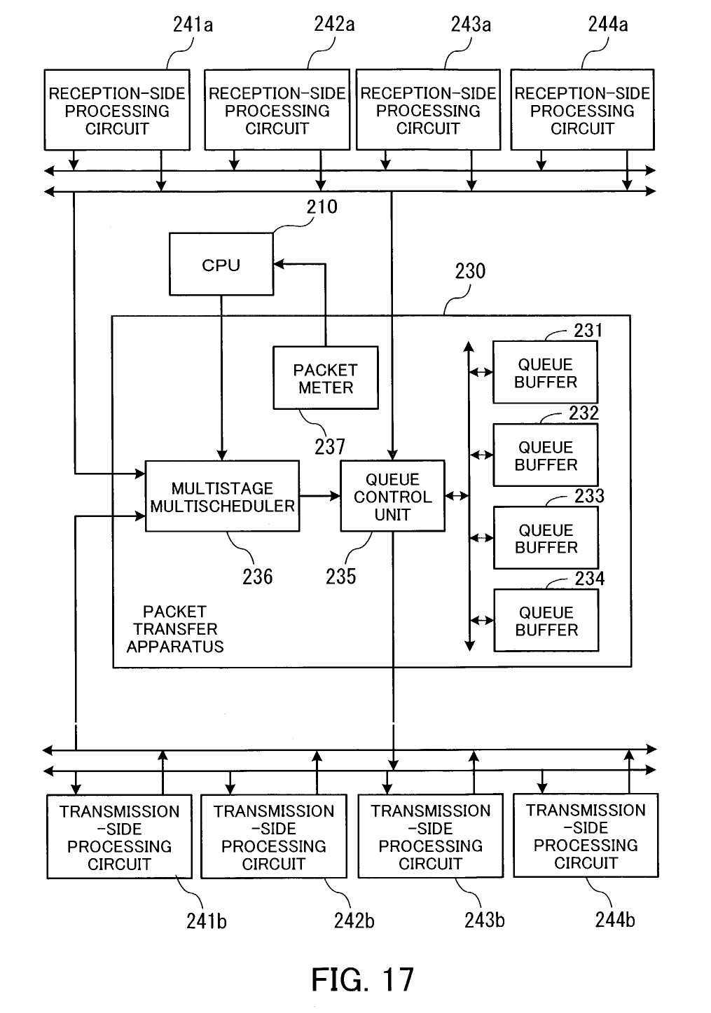

FIG. 17 is a block diagram illustrating an internal construction of the packet transfer apparatus in the second embodiment of the present invention. In FIG. 17, in order to clarify the data flow, the functions of the plurality of communication interfaces 241 to 244 are separately indicated as reception-side processing circuits 241a, 242a, 243a, and 244a and transmission-side processing circuits 241b, 242b, 243b, and 244b.

The packet transfer apparatus 230 comprises a plurality of queue buffers 231 to 234, a queue control unit 235, a multistage multischeduler 236, and a packet meter 237.

The plurality of queue buffers 231 to 234 are buffer memories for queuing packets received by the plurality of communication interfaces 241 to 244, respectively. The plurality of queue buffers 231 to 234 are partitioned into a plurality of buffer areas corresponding to a plurality of priorities of packets. Packets input into the communication interface 241 are queued in the queue buffer 231, packets input into the communication interface 242 are queued in the queue buffer 232, packets input into the communication interface 243 are queued in the queue buffer 233, and packets input into the communication interface 244 are queued in the queue buffer 234.

The queue control unit 235 acquires packets received by the reception-side processing circuits 241a, 242a, 243a, and 244a in the plurality of communication interfaces 241 to 244, in accordance with information from the multistage multischeduler 236, and stores the acquired packets in the plurality of queue buffers 231 to 234. In addition, the queue control unit 235 reads out the stored packets from the plurality of queue buffers 231 to 234, in accordance with information from the multistage multischeduler 236, and passes each of the packets to one of the transmission-side processing circuits 241b, 242b, 243b, and 244b in the plurality of communication interfaces 241 to 244 which is connected to a destination of the packet.

The multistage multischeduler 236 is connected to the CPU 210, the plurality of queue buffers 231 to 234, the queue control unit 235, the reception-side processing circuits 241a, 242a, 243a, and 244a, and the transmission-side processing circuits 241b, 242b, 243b, and 244b. The multistage multischeduler 236 receives requests from the reception-side processing circuits 241a, 242a, 243a, and 244a and the transmission-side processing circuits 241b, 242b, 243b, and 244b in the plurality of communication interfaces 241 to 244, and performs scheduling of timings of storage of packets in the plurality of queue buffers 231 to 234 and transmission of the packets. In addition, the multistage multischeduler 236 sends to the queue control unit 235 information designating details of processing of the packets, in accordance with a schedule.

Further, the CPU 210 writes in the multistage multischeduler 236 boundary values and initial values of entry registers for the scheduling. The CPU 210 can dynamically rewrite the boundary values and the values of the entry registers during operations of the data transfer apparatus 200.

The packet meter 237 is a circuit for monitoring the respective elements of the packet transfer apparatus 230 and confirming whether or not packets are transferred in accordance with a profile which is preset. For example, a minimum transfer rate for each type of request is set in the profile. When a transfer does not comply with the profile, the packet meter 237 notifies the CPU 210 of the noncompliance.

In the packet transfer apparatus 230 having the above construction, packets which are input through the plurality of input/output ports 251 to 254 and received by the reception-side processing circuits 241a, 242a, 243a, and 244a in the plurality of communication interfaces 241 to 244 are stored in the plurality of queue buffers 231 to 234 by the queue control unit 235 in accordance with the schedule determined by the multistage multischeduler 236. In addition, the packets stored in the plurality of queue buffers 231 to 234 are passed to the transmission-side processing circuits 241b, 242b, 243b, and 244b in the plurality of communication interfaces 241 to 244 by the queue control unit 235 in accordance with the schedule determined by the multistage multischeduler 236. The packets passed to the transmission-side processing circuits 241b, 242b, 243b, and 244b are transmitted to a network through the plurality of input/output ports 251 to 254.

When a transfer rate in a communication to which a high priority is assigned falls below a specified value, the packet meter 237 notifies the CPU 210 of the fall of the transfer rate. In response to the notification, the CPU 210 changes various data in the multistage multischeduler 236 which affect the schedule so that the transfer rate can be maintained above the specified value in the communication to which a high priority is assigned.

Next, details of the internal construction of the multistage multischeduler are explained.

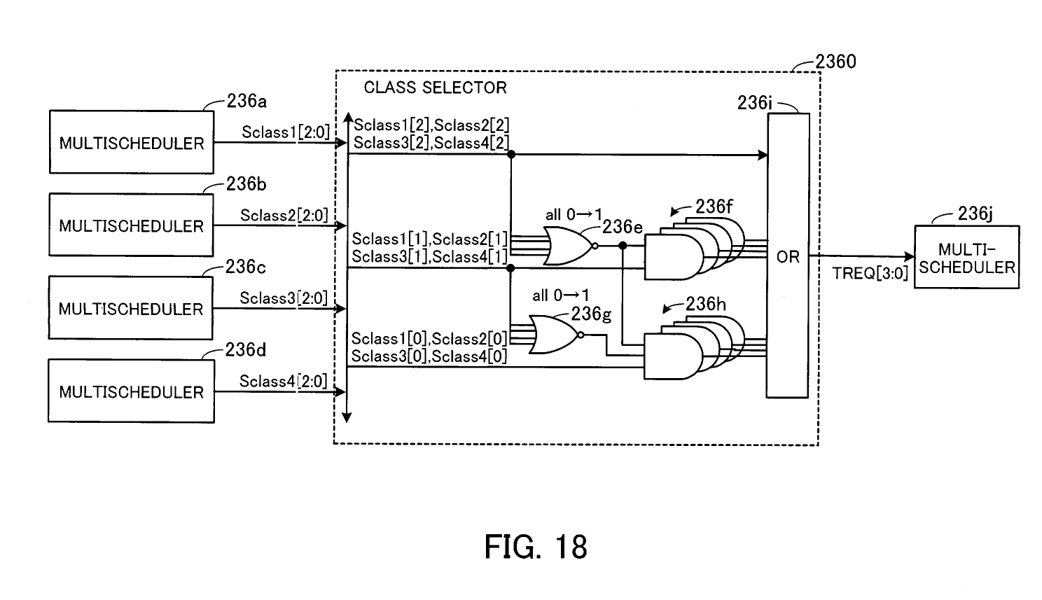

FIG. 18 is a block diagram illustrating a construction of the multistage multischeduler. In FIG. 18, a portion of the functions of the multistage multischeduler for scheduling transmission timings of packets queued in the plurality of queue buffers 231 to 234 is indicated.

The multistage multischeduler 236 comprises a plurality of first-stage multischedulers 236a to 236d, NOR circuits 236e and 236g, groups of AND circuits 236f and 236h, an OR circuit 236i, and a second-stage multischeduler 236j. Each of the two groups of AND circuits 236f and 236h includes four AND circuits. The NOR circuits 236e and 236g, the two groups of AND circuits 236f and 236h, and the OR circuit 236i constitute a class selector 2360. The class selector 2360 selects at least one request having the highest priority from among transmission requests which have been selected by the plurality of first-stage multischedulers 236a to 236d as objects of service, and passes the at least one request to the second-stage multischeduler 236j.

In the second embodiment, it is necessary to determine the communication interfaces as the objects of service so that the service on packets stored in the buffer areas is executed in descending order of the priorities of the buffer areas. Therefore, in order to discriminate between the respective priorities, signals indicating service classes are exchanged between the multischedulers. In FIG. 18, the service classes are indicated by service class signals Sclass1[2:0], Sclass2[2:0], Sclass3[2:0], and Sclass4[2:0].

When an entry which is currently receiving service from the first-stage multischeduler 236a is in an entry register having a priority equal to or higher than a priority of an entry register indicated by a value in a first boundary register, the bit 2 in the service class signal Sclass1[2:0] is turned on. This indicates that the service class is the priority queuing (PQ). When the entry which is currently receiving service from the first-stage multischeduler 236a is in an entry register having a priority lower than the priority of the entry register indicated by the value in the first boundary register and equal to or higher than a priority of an entry register indicated by a value in a second boundary register, the bit 1 in the service class signal Sclass1[2:0] is turned on. This indicates that the service class is the weighted-round-robin queuing (WRQ). When the entry which is currently receiving service from the first-stage multischeduler 236a is in an entry register having a priority lower than the priority of the entry register indicated by the value in the second boundary register, the bit 0 in the service class signal Sclass1[2:0] is turned on. This indicates that the service class is the best-effort queuing (BEQ).

If a further service class is defined in addition to the PQ, WRQ, and BEQ, it is easy to adapt the multistage multischeduler 236 to the increase in the service class by increasing the boundary registers. Similarly, the other service class signals Sclass2[2:0], Sclass3[2:0], and Sclass4[2:0] indicate service classes currently receiving service from the first-stage multischedulers 236b to 236d, respectively. Hereinafter, a transmission request selected by each first-stage multischeduler as an object of the service is referred to as a service candidate.

By using the above mechanism, the multistage multischeduler as illustrated in FIG. 18 is constructed.

The plurality of first-stage multischedulers 236a to 236d are respectively associated with the plurality of queue buffers 231 to 234, and transmission requests from the corresponding queue buffers are respectively input into the plurality of first-stage multischedulers 236a to 236d. The first-stage multischeduler 236a corresponds to the queue buffer 231, the first-stage multischeduler 236b corresponds to the queue buffer 232, the first-stage multischeduler 236c corresponds to the queue buffer 233, and the first-stage multischeduler 236d corresponds to the queue buffer 234.

The plurality of first-stage multischedulers 236a to 236d respectively perform scheduling of packets queued in the corresponding queue buffers 231 to 234, and determine transmission requests as service candidates. Then, the plurality of first-stage multischedulers 236a to 236d respectively output the service class signals Sclass1[2:0], Sclass2[2:0], Sclass3[2:0], and Sclass4[2:0], where each of the service class signals is information indicating a priority of a transmission request as a service candidate.

In the second embodiment, the priorities are classified into three levels, where transmission requests corresponding to the priority queuing (PQ) have the highest priority, transmission requests corresponding to the weighted-round-robin queuing (WRQ) have the second highest priority, and transmission requests corresponding to the best-effort queuing (BEQ) have the lowest priority. The service class signals each have a plurality of bits the number of which corresponds to the number of the priority levels, and in each service class signal, only a bit corresponding to the priority level of the corresponding transmission request as the service candidate is an effective value “1.”

Signal lines corresponding to each priority level in the service class signals Sclass1[2:0], Sclass2[2:0], Sclass3[2:0], and Sclass4[2:0] output from the plurality of first-stage multischedulers 236a to 236d are bundled. That is, a set of signals Sclass1[2], Sclass2[2], Sclass3[2], and Sclass4[2] indicating transmission requests corresponding to the priority queuing (PQ) is brought together into a bundle, a set of signals Sclass1[1], Sclass2[1], Sclass3[1], and Sclass4[1] indicating transmission requests corresponding to the weighted-round-robin queuing (WRQ) is brought together into a bundle, and a set of signals Sclass1[0], Sclass2[0], Sclass3[0], and Sclass4[0] indicating transmission requests corresponding to the best-effort queuing (BEQ) is brought together into a bundle.

The bundle of the signals Sclass1[2], Sclass2[2], Sclass3[2], and Sclass4[2] indicating transmission requests corresponding to the priority queuing (PQ) is input into the NOR circuit 236e and the OR circuit 236i. The signals Sclass1[1], Sclass2[1], Sclass3[1], and Sclass4[1] indicating transmission requests corresponding to the weighted-round-robin queuing (WRQ) are respectively input into the AND circuits constituting the group 236f, and all of the signals Sclass1[1], Sclass2[1], Sclass3[1], and Sclass4[1] are input into the NOR circuit 236g. The signals Sclass1[0], Sclass2[0], Sclass3[0], and Sclass4[0] indicating transmission requests corresponding to the best-effort queuing (BEQ) are respectively input into the AND circuits constituting the group 236h.

The output of the NOR circuit 236e is input into each AND circuit constituting the two groups of AND circuits 236f and 236h, and the output of the NOR circuit 236g is input into each AND circuit constituting the group of AND circuits 236h. The outputs of the two groups of AND circuits 236f and 236h are input into the OR circuit 236i.

Each of the NOR circuits 236e and 236g outputs “1” when all of the inputs into the NOR circuit are “0.” That is, if at least one of the inputs of each of the NOR circuits 236e and 236g is “1,” the output of the NOR circuit is “0.”

Each AND circuit in the group 236f calculates a logical product of the output of the NOR circuit 236e and one of the signals Sclass1[1], Sclass2[1], Sclass3[1], and Sclass4[1]. For example, when the input from the NOR circuit 236e is “0,” the group of AND circuits 236f convert all of the signals indicating the transmission requests corresponding to the weighted-round-robin queuing (WRQ) into “0.” When the input from the NOR circuit 236e is “1,” the group of AND circuits 236f output the transmission requests corresponding to the weighted-round-robin queuing (WRQ) as they are.

Each AND circuit in the group 236h calculates a logical product of the outputs of the two NOR circuits 236e and 236g and one of the signals Sclass1[0], Sclass2[0], Sclass3[0], and Sclass4[0]. For example, when at least one of the inputs from the two NOR circuits 236e and 236g is “0,” the group of AND circuits 236h convert all of the signals indicating the transmission requests corresponding to the best-effort queuing (BEQ) into “0.” When both of the inputs from the NOR circuit 236e are “1,” the group of AND circuits 236h output the transmission requests corresponding to the best-effort queuing (BEQ) as they are.

The output of the OR circuit 236i is input into the second-stage multischeduler 236j. The OR circuit 236i receives the bundle of the signals Sclass1[2], Sclass2[2], Sclass3[2], and Sclass4[2] and the outputs of the groups of AND circuits 236f and 236h, and rebundle the received signals into signals Sclass1a[2:0], Sclass2a[2:0], Sclass3a[2:0], and Sclass4a[2:0] corresponding to each of the plurality of first-stage multischedulers 236a to 236d. Then, the OR circuit 236i calculates logical sums for each service class, and outputs the calculated result. The signals Sclass1a[2:0], Sclass2a[2:0], Sclass3a[2:0], and Sclass4a[2:0] are service class signals which are generated when the signals Sclass1[2], Sclass2[2], Sclass3[2], and Sclass4[2] pass through the NOR circuits 236e and 236g, the groups of AND circuits 236f and 236h, and the OR circuit 236i. The output signals from the OR circuit 236i constitute a set of request signals TREQ[3:0] to be supplied to the second-stage multischeduler 236j.

The second-stage multischeduler 236j performs scheduling which determines a communication interface into which a packet allowed to receive the service has been input, based on the set of request signals TREQ[3:0], and supplies the result to the queue control unit 235.

In the multistage multischeduler 236 having the above construction, the plurality of first-stage multischedulers 236a to 236d output the service class signals Sclass1[2:0], Sclass2[2:0], Sclass3[2:0] and Sclass4[2:0], which indicate priority classes of packets queued in the plurality of queue buffers 231 to 234, respectively. When the service class signals pass through the NOR circuits 236e and 236g, the groups of AND circuits 236f and 236h, and the OR circuit 236i, the set of request signals TREQ[3:0] are generated, where the set of request signals TREQ[3:0] indicate at least one of the plurality of queue buffers 231 to 234 storing at least one packet which has the highest priority among the packets currently stored in the plurality of queue buffers 231 to 234.

For example, when at least one queue buffer stores a packet for the priority queuing (PQ), the set of request signals TREQ[3:0] indicate the at least one queue buffer. Alternatively, when none of the plurality of queue buffers 231 to 234 stores a packet for the priority queuing (PQ), and at least one queue buffer stores a packet for the weighted-round-robin queuing (WRQ), the set of request signals TREQ[3:0] indicate the at least one queue buffer storing the packet for the weighted-round-robin queuing (WRQ). Further, when none of the plurality of queue buffers 231 to 234 stores a packet for the priority queuing (PQ) or the weighted-round-robin queuing (WRQ), and at least one queue buffer stores a packet for the best-effort queuing (BEQ), the set of request signals TREQ[3:0] indicate the at least one queue buffer storing the packet for the best-effort queuing (BEQ).

In the second-stage multischeduler 236j into which the set of request signals TREQ[3:0] are input, at least one transmission request having the highest priority and being stored in the at least one queue buffer indicated by the set of request signals TREQ[3:0] is executed on a round-robin basis.

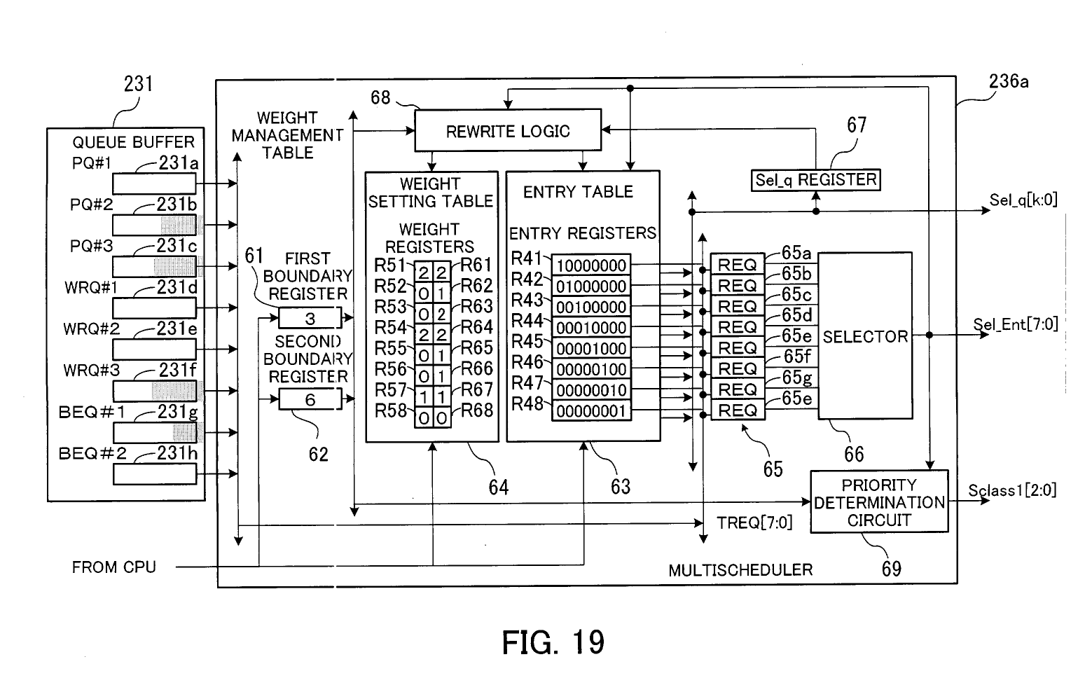

FIG. 19 is a block diagram illustrating a construction of a first-stage multischeduler. The first-stage multischeduler 236a comprises a first boundary register 61, a second boundary register 62, an entry table 63, a weight setting table 64, an entry determination unit 65, a selector 66, a queue selection register 67, a rewrite logic 68, and a priority determination circuit 69. The queue buffer 231 is partitioned into eight buffer areas 231a to 231h. The entry table 63 includes eight entry registers R41 to R48. The weight setting table 64 includes eight weight registers R51 to R58 and eight initial-value registers R61 to R68. The constituents of the first-stage multischeduler 236a except for the priority determination circuit 69 respectively have the same functions as the constituents of the multischeduler 133 in the first embodiment being illustrated in FIG. 4 and having the same names as the constituents of the first-stage multischeduler 236a.

The priority determination circuit 69 receives values in the first boundary register 61 and the second boundary register 62 and a multibit selection signal Sel_Ent[7:0], determines a priority of an entry register indicated by the multibit selection signal Sel_Ent[7:0], based on the values in the first boundary register 61 and the second boundary register 62, and outputs a value indicating the priority as a service class signal Sclass1[2:0], where the multibit selection signal Sel_Ent[7:0] is output from the selector 66.

In the first-stage multischeduler 236a having the above construction, one of at least one packet having the highest priority among at least one packet queued in the queue buffer 231 is selected on a round-robin basis. In addition, the multibit selection signal Sel_Ent[7:0] indicating an entry register corresponding to the selected packet is output, where the entry register stores data indicating a buffer area in the queue buffer 231 in which the selected packet is stored. At the same time, a queue selection signal Sel_q[7:0] indicating the buffer area in the queue buffer 231 in which the selected packet is stored is output. These signals are passed to the queue control unit 235 when a service on a packet stored in the queue buffer 231 is determined by the second-stage multischeduler 236j. At this time, a transmission request corresponding to the buffer area in the queue buffer 231 which is indicated by the queue selection signal Sel_q[7:0] is the transmission request as the aforementioned service candidate.

In addition, the first-stage multischeduler 236a outputs the service class signal Sclass1[2:0] indicating the priority of the buffer area corresponding to the transmission request as the service candidate.

Although only the first-stage multischeduler 236a is indicated in FIG. 19, each of the first-stage multischedulers 236b to 236d has a similar construction to the first-stage multischeduler 236a. Therefore, each of the first-stage multischedulers 236b to 236d determines a transmission request as a service candidate, and the service class signals Sclass2a[2:0], Sclass3a[2:0], and Sclass4a[2:0] are output from the first-stage multischedulers 236b to 236d.

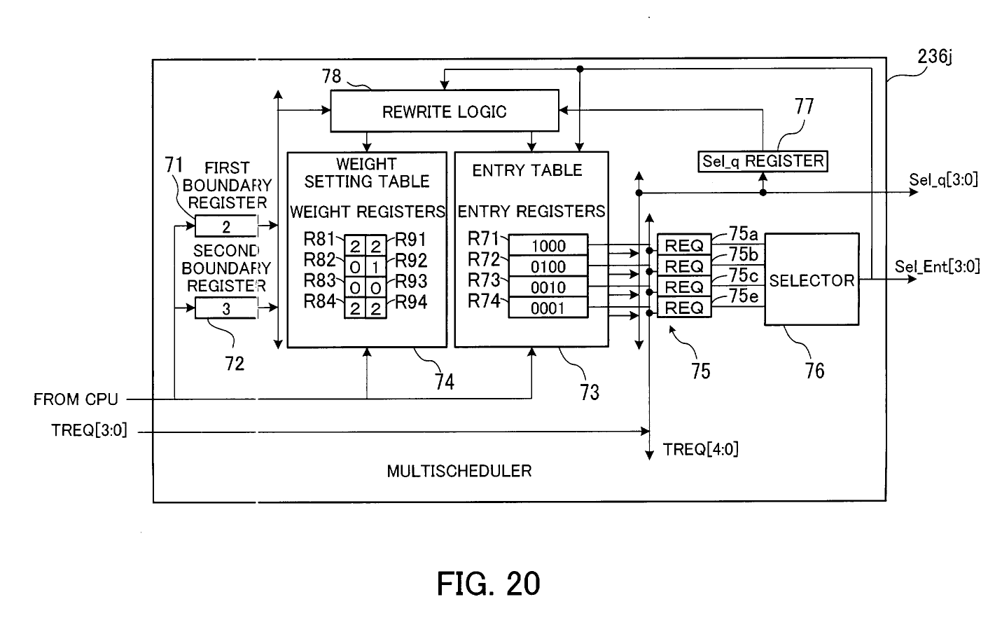

FIG. 20 is a block diagram illustrating a construction of the second-stage multischeduler. The second-stage multischeduler 236j comprises a first boundary register 71, a second boundary register 72, an entry table 73, a weight setting table 74, an entry determination unit 75, a selector 76, a queue selection register 77, and a rewrite logic 78. The entry table 73 includes four entry registers R71 to R74. The weight setting table 74 includes four weight registers R81 to R84 and four initial-value registers R91 to R94. Each of the number (four) of the entry registers R71 to R74, the number (four) of the weight registers R81 to R84, and the number (four) of the initial-value registers R91 to R94 corresponds to the number of the plurality of queue buffers 231 to 234. The constituents of the second-stage multischeduler 236j respectively have the same functions as the constituents of the multischeduler 133 in the first embodiment being illustrated in FIG. 4 and having the same names as the constituents of the second-stage multischeduler 236j, except that a set of request signals TREQ[3:0] are output from the OR circuit 236i.

In the second-stage multischeduler 236j having the above construction, it is possible to realize priority control of at least one transmission request from each of at least one of the plurality of queue buffers 231 to 234 which is indicated by the set of request signals TREQ[3:0], based on values of the first boundary register 71 and the second boundary register 72.

In the example of FIG. 20, the value “1000” in the entry register R71 indicates the queue buffer 231, the value “0100” in the entry register R72 indicates the queue buffer 232, the value “0010” in the entry register R73 indicates the queue buffer 233, and the value “0001” in the entry register R74 indicates the queue buffer 234. At this time, when “2” is set in the first boundary register 71, and “3” is set in the second boundary register 72, the queue buffers 231 and 232 have the highest priority, the queue buffer 233 has the second highest priority, and the queue buffer 234 has the lowest priority, i.e., the communication interfaces 241 and 242 have the highest priority, the communication interface 243 has the second highest priority, and the communication interface 244 has the lowest priority.

That is, first, packets queued in the queue buffers 231 and 232 receive the service, next at least one packet queued in the queue buffer 233 receives the service, and finally at least one packet queued in the queue buffer 234 receives the service. In this case, transmission requests which are selected as service candidates by multischedulers indicated by the set of request signals TREQ[3:0] receive the service, where each multischeduler selects as a service candidate a transmission request having currently the highest priority.

As explained above, it is possible to realize packet transfer based on consideration of a priority order of packets for each of a plurality of communication interfaces. That is, various service rotations such as a service in which a weight is added to each communication interface are enabled by the setting in the multistage multischeduler 236. For example, it is possible to raise the priority of a communication interface connected to a network used in business, and increase the transfer rate of packets transmitted through the communication interface. In addition, the priority of each communication interface can be dynamically changed by changing the values in the first boundary register 71 and the second boundary register 72 in the second-stage multischeduler 236j.

[Other Applications]

In the first and second embodiments, the present invention is applied to data transfer apparatuses. However, the present invention can be applied to various apparatuses which transfer packets, as well as the data transfer apparatuses. For example, the present invention can be applied to routers, bridges, switching devices, and the like.

Although, in the first and second embodiments, the boundary values are automatically updated based on the monitoring results of the transfer rates, the boundary values may be updated in response to user manipulations.

In addition, the construction of FIG. 2 can be implemented as a portion of another apparatus. For example, when a data transfer apparatus is connected to a plurality of networks, the apparatus according to the present invention can be used for an output port connected to one of the plurality of networks the transfer rate of which is smaller than transfer rates of the other of the plurality of networks.

As explained above, according to the present invention, priorities of a plurality of buffer areas are determined based on information which can be changed during a packet transfer operation, and a buffer area which stores a packet having an attribute to be transmitted is selected based on the priorities at a packet transmission timing. Therefore, when information indicating the priorities is changed according to an operational situation in packet processing or the like, it is possible to dynamically change a transfer rate for each attribute according to the operational situation or the like.

In the first and second embodiments, higher priorities are assigned to upper ones of the buffer areas 131a to 131h in FIG. 4. However, priorities may be assigned to the buffer areas 131a to 131h regardless of the order in which the buffer areas 131a to 131h are indicated in FIG. 4. In this case, identification numbers of buffer areas having higher priorities are set in upper ones of the entry registers R11 to R18 when the entry registers R11 to R18 are initialized or rearranged corresponding to a change in at least one value of at least one boundary register. For example, when the buffer areas 131a, 131b, and 131d are used for the priority queuing (PQ), and the buffer areas 131c, 131e, and 131f are used for the weighted-round-robin queuing (WRQ), a plurality of sets of values “10000000,” “01000000,” “00010000,” “00100000,” “00001000,” “00000100,” . . . are registered in the entry registers R11 to R18, respectively. Thus, a grouping corresponding to the priorities of the buffer areas 131a to 131h can be realized regardless of the arrangement of the buffer areas 131a to 131h.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A packet transfer apparatus for transferring communication packets, comprising:
a buffer memory partitioned into a plurality of buffer areas;
a buffer control circuit which determines at least one attribute of at least one packet which is input into said packet transfer apparatus, stores the at least one packet in at least one of said plurality of buffer areas which is respectively associated with the at least one attribute in advance, and outputs a packet stored in one of said plurality of buffer areas when said one of said plurality of buffer areas is selected;
a plurality of registers in which information indicating priorities of said plurality of buffer areas is set, where the information can be changed during packet transfer processing; and
a selector which refers to said information set in said plurality of registers at a packet transmission timing, selects one of said plurality of buffer areas which has a highest priority among at least one of said plurality of buffer areas storing at least one packet, and sends a selection result to said buffer control circuit.

2. A packet transfer apparatus according to claim 1, wherein at least one value indicating at least one boundary between the priorities is set in said at least one register.

3. A packet transfer apparatus according to claim 2, wherein said at least one register is more than register provided for each of a plurality of boundaries between the priorities.

4. A packet transfer apparatus according to claim 1, wherein when more than one of said plurality of buffer areas has the highest priority, said selector selects the more than one of said plurality of buffer areas in turn until no packet is left in the more than one of said plurality of buffer areas.

5. A packet transfer apparatus according to claim 4, further comprising a table in which weights assigned to said plurality of buffer areas are set,
in selection of each of said plurality of buffer areas, said selector consecutively selects said each of said plurality of buffer areas a number of times corresponding to a weight assigned to said each of the plurality of buffer areas.

6. A packet transfer apparatus according to claim 1, further comprising a packet meter which monitors a transfer rate of packets.

7. A packet transfer apparatus according to claim 6, wherein a specification value for the transfer rate is preset in said packet meter, and the packet meter outputs an alarm when the transfer rate falls below the specification value.

8. A packet transfer apparatus according to claim 7, wherein said specification value is preset for each attribute of packets.

9. A packet transfer apparatus for transferring communication packets, comprising:
a plurality of buffer memories provided for each communication interface, where each of the plurality of buffer memories is partitioned into a plurality of buffer areas;
a buffer control circuit which determines at least one attribute of at least one packet which is input into said packet transfer apparatus, stores the at least one packet in at least one of said plurality of buffer areas which is respectively associated with the at least one attribute in advance, in at least one of said plurality of buffer memories corresponding to at least one communication interface to which the at least one packet is to be output, and outputs a packet stored in one of said plurality of buffer areas in one of the plurality of buffer memories when the one of the plurality of buffer areas in the one of the plurality of buffer memories is selected;
a plurality of first-stage schedulers corresponding to said plurality of buffer memories and each including a first register and a first selector, where information which indicates priorities of said plurality of buffer areas and can be varied during packet transfer processing is set in said first register, and said first selector refers to said information set in said first register at a packet transfer timing, selects one of said plurality of buffer areas which has a highest priority among at least one of the plurality of buffer areas storing at least one packet, and sends a selection result to said buffer control circuit; and
a second-stage scheduler including a second register and a second selector, where information which indicates priorities of said plurality of buffer memories and can be dynamically varied is set in said second register, and said second selector refers to said information set in said second register when a packet can be transmitted, selects one of said plurality of buffer memories which has a highest priority among at least one of the plurality of buffer memories storing at least one packet, and sends a selection result to said buffer control circuit.

10. A scheduler for determining an order of transmission of packets stored in a buffer memory partitioned into a plurality of buffer areas, comprising:
a register in which information which indicates priorities of said plurality of buffer areas and can be varied during packet transfer processing is set; and
a selector which refers to said information set in said first register at a packet transfer timing, selects one of said plurality of buffer areas which has a highest priority among at least one of the plurality of buffer areas storing at least one packet, and determines a packet stored in the selected one of the plurality of buffer areas, to be transmitted.

11. A data transfer apparatus for transferring data between a plurality of networks, comprising:
a first communication port;
a second communication port;
a buffer memory partitioned into a plurality of buffer areas;
a buffer control circuit which determines at least one attribute of at least one packet which is input through said first communication port, stores the at least one packet in at least one of said plurality of buffer areas which is respectively associated with the at least one attribute in advance, and outputs through said second communication port a packet stored in one of said plurality of buffer areas when the one of the plurality of buffer areas is selected;
a plurality of registers in which information indicating priorities of said plurality of buffer areas is set, where the information can be changed during packet transfer processing;
a selector which refers to said information set in said plurality of registers at a packet transmission timing, selects one of said plurality of buffer areas which has a highest priority among at least one of said plurality of buffer areas storing at least one packet, and sends a selection result to said buffer control circuit; and
a processor which dynamically changes said information set in said plurality of registers.

12. A data transfer apparatus according to claim 11, further comprising a packet meter which monitors a transfer rate of packets.

13. A data transfer apparatus according to claim 12, wherein a specification value for the transfer rate is preset in said packet meter, and the packet meter changes the information set in said plurality of registers.

14. A packet transfer method for transferring communication packets through a buffer memory partitioned into a plurality of buffer areas, comprising the steps of:
(a) determining at least one attribute of at least one packet which is input, and storing the at least one packet in at least one of said plurality of buffer areas which is respectively associated with the at least one attribute in advance;
(b) at a packet transmission timing, referring to information indicating priorities of said plurality of buffer areas, and selecting one of said plurality of buffer areas which has a highest priority among at least one of said plurality of buffer areas storing at least one packet; and
(c) outputting a packet stored in the selected one of said plurality of buffer areas.
